(19) United States
(12) Patent Application Publication
(10) Pub. No.: US 2024/0412402 A1
(43) Pub. Date: Dec. 12, 2024

(54) INFORMATION PROCESSING APPARATUS AND INFORMATION PROCESSING METHOD

(71) Applicant: NEC Corporation, Minato-ku, Tokyo (JP)

(72) Inventor: Masaya Fujiwaka, Tokyo (JP)

(73) Assignee: NEC Corporation, Minato-ku, Tokyo (JP)

(21) Appl. No.: 18/699,350

(22) PCT Filed: Oct. 12, 2021
(86) PCT No.: PCT/JP2021/037649

§ 371 Date: Apr. 8, 2024

(51) Int. Cl. G06T 7/70; G06T 7/13; G06T 7/50; G06V 10/44; G06V 10/75

(52) U.S. Cl. CPC G06T 7/70; G06T 7/13; G06T 7/50; G06V 10/44; G06V 10/751

(57) ABSTRACT

At least one processor of an information processing apparatus performs: a depth information acquiring process of acquiring depth information; a captured image acquiring process of acquiring a captured image; a generating process of generating, with reference to first two-dimensional data and a three-dimensional model regarding the target object, a candidate solution regarding at least one selected from the group consisting of the position and the attitude of the target object in a three-dimensional space, the first two-dimensional data being obtained with reference to the depth information; and a calculating process of calculating, with reference to second two-dimensional data and the three-dimensional model and with use of the candidate solution, at least one selected from the group consisting of the position and the attitude of the target object in the three-dimensional space, the second two-dimensional data being obtained with reference to the captured image.

### TECHNICAL FIELD

The present invention relates to an information processing apparatus, an information processing method, an information processing system, and a recording medium for calculating at least one selected from the group consisting of a position and an attitude of a target object.

### BACKGROUND ART

Techniques have been known for estimating the position and the attitude of a target object in a real space by analyzing a captured image which is captured with the target object lying within the angle of view.

For example, Non-Patent Literature 1 discloses a technique for estimating the position and the attitude of a target object by comparing two-dimensional data and a captured image captured with the target object lying within the angle of view, the two-dimensional data being obtained through two-dimensional projection of three-dimensional point cloud data, generated in advance, of the target object.

### CITATION LIST

### Non-Patent Literature

### [Non-patent Literature 1]

Martin A. Fischler, Robert C. Bolles, “Random Sample Consensus: A Paradigm for Model Fitting with Applications to Image Analysis and Automated Cartography”, Jun. 1, 1981

### SUMMARY OF INVENTION

### Technical Problem

With the technique of Non-Patent Literature 1, it is necessary to search 6-axis space having axes of position (x,y,z) and an attitude (roll, pitch, yaw), and the search space is thus enormous. The technique of Non-Patent Literature 1 therefore presents a problem of increased computational cost and computational time.

An example aspect of the present invention has been made in view of the above problem, and an example object is to provide a technique for making it possible to suitably estimate at least one selected from the group consisting of the position and the attitude of a target object while reducing computational cost and computational time.

### Solution to Problem

An information processing apparatus in accordance with an example aspect of the present invention includes: a depth information acquiring means for acquiring depth information obtained via a depth sensor having a sensing range within which a target object lies; a captured image acquiring means for acquiring a captured image obtained via an imaging sensor having an angle of view within which the target object lies; a generating means for generating, with reference to first two-dimensional data and third two-dimensional data, one or more candidate solutions regarding at least one selected from the group consisting of a position and an attitude of the target object in a three-dimensional space, the first two-dimensional data being obtained through a first feature extracting process in which the depth information is referred to, the third two-dimensional data being obtained through a first feature extracting process in which an image resulting from mapping of a three-dimensional model regarding the target object to a two-dimensional space is referred to; and a calculating means for calculating, with reference to second two-dimensional data and fourth two-dimensional data and with use of the one or more candidate solutions, at least one selected from the group consisting of the position and the attitude of the target object in the three-dimensional space, the second two-dimensional data being obtained through a second feature extracting process in which the captured image is referred to, the fourth two-dimensional data being obtained through a second feature extracting process in which an image resulting from mapping of the three-dimensional model regarding the target object to the two-dimensional space is referred to.

An information processing apparatus in accordance with an example aspect of the present invention includes: a depth information acquiring means for acquiring depth information obtained via a depth sensor having a sensing range within which a target object lies; a captured image acquiring means for acquiring a captured image obtained via an imaging sensor having an angle of view within which the target object lies; a first matching means for performing a first matching process in which first two-dimensional data and third two-dimensional data are referred to, the first two-dimensional data being obtained through a first feature extracting process in which the depth information is referred to, the third two-dimensional data being obtained through a first feature extracting process in which an image resulting from mapping of a three-dimensional model regarding the target object to a two-dimensional space is referred to; a second matching means for performing a second matching process in which second two-dimensional data and fourth two-dimensional data are referred to, the second two-dimensional data being obtained through a second feature extracting process in which the captured image is referred to, the fourth two-dimensional data being obtained through a second feature extracting process in which an image resulting from mapping of the three-dimensional model regarding the target object to the two-dimensional space is referred to; and a calculating means for calculating at least one selected from the group consisting of a position and an attitude of the target object in the three-dimensional space, with reference to a result of the first matching process and a result of the second matching process.

An information processing method in accordance with an example aspect of the present invention includes: acquiring depth information obtained via a depth sensor having a sensing range within which a target object lies; acquiring a captured image obtained via an imaging sensor having an angle of view within which the target object lies; generating, with reference to first two-dimensional data and third two-dimensional data, one or more candidate solutions regarding at least one selected from the group consisting of a position and an attitude of the target object in a three-dimensional space, the first two-dimensional data being obtained through a first feature extracting process in which the depth information is referred to, the third two-dimensional data being obtained through a first feature extracting process in which an image resulting from mapping of a three-dimensional model regarding the target object to a two-dimensional space is referred to; and calculating, with reference to second two-dimensional data and fourth two-dimensional data and with use of the one or more candidate solutions, at least one selected from the group consisting of the position and the attitude of the target object in the three-dimensional space, the second two-dimensional data being obtained through a second feature extracting process in which the captured image is referred to, the fourth two-dimensional data being obtained through a second feature extracting process in which an image resulting from mapping of the three-dimensional model regarding the target object to the two-dimensional space is referred to.

An information processing method in accordance with an example aspect of the present invention includes: acquiring depth information obtained via a depth sensor having a sensing range within which a target object lies; acquiring a captured image obtained via an imaging sensor having an angle of view within which the target object lies; performing a first matching process in which first two-dimensional data and third two-dimensional data are referred to, the first two-dimensional data being obtained through a first feature extracting process in which the depth information is referred to, the third two-dimensional data being obtained through a first feature extracting process in which an image resulting from mapping of a three-dimensional model regarding the target object to a two-dimensional space is referred to; performing a second matching process in which second two-dimensional data and fourth two-dimensional data are referred to, the second two-dimensional data being obtained through a second feature extracting process in which the captured image is referred to, the fourth two-dimensional data being obtained through a second feature extracting process in which an image resulting from mapping of the three-dimensional model regarding the target object to the two-dimensional space is referred to; and calculating at least one selected from the group consisting of a position and an attitude of the target object in the three-dimensional space, with reference to a result of the first matching process and a result of the second matching process.

An information processing system in accordance with an example aspect of the present invention includes: a depth information acquiring means for acquiring depth information obtained via a depth sensor having a sensing range within which a target object lies; a captured image acquiring means for acquiring a captured image obtained via an imaging sensor having an angle of view within which the target object lies; a generating means for generating, with reference to first two-dimensional data and third two-dimensional data, one or more candidate solutions regarding at least one selected from the group consisting of a position and an attitude of the target object in a three-dimensional space, the first two-dimensional data being obtained through a first feature extracting process in which the depth information is referred to, the third two-dimensional data being obtained through a first feature extracting process in which an image resulting from mapping of a three-dimensional model regarding the target object to a two-dimensional space is referred to; and a calculating means for calculating, with reference to second two-dimensional data and fourth two-dimensional data and with use of the one or more candidate solutions, at least one selected from the group consisting of the position and the attitude of the target object in the three-dimensional space, the second two-dimensional data being obtained through a second feature extracting process in which the captured image is referred to, the fourth two-dimensional data being obtained through a second feature extracting process in which an image resulting from mapping of the three-dimensional model regarding the target object to the two-dimensional space is referred to.

An information processing system in accordance with an example aspect of the present invention includes: a depth information acquiring means for acquiring depth information obtained via a depth sensor having a sensing range within which a target object lies; a captured image acquiring means for acquiring a captured image obtained via an imaging sensor having an angle of view within which the target object lies; a first matching means for performing a first matching process in which first two-dimensional data and third two-dimensional data are referred to, the first two-dimensional data being obtained through a first feature extracting process in which the depth information is referred to, the third two-dimensional data being obtained through a first feature extracting process in which an image resulting from mapping of a three-dimensional model regarding the target object to a two-dimensional space is referred to; a second matching means for performing a second matching process in which second two-dimensional data and fourth two-dimensional data are referred to, the second two-dimensional data being obtained through a second feature extracting process in which the captured image is referred to, the fourth two-dimensional data being obtained through a second feature extracting process in which an image resulting from mapping of the three-dimensional model regarding the target object to the two-dimensional space is referred to; and a calculating means for calculating at least one selected from the group consisting of a position and an attitude of the target object in the three-dimensional space, with reference to a result of the first matching process and a result of the second matching process.

A recording medium in accordance with an example aspect of the present invention is a computer-readable recording medium having recorded thereon a program for causing a computer to function as: a depth information acquiring means for acquiring depth information obtained via a depth sensor having a sensing range within which a target object lies; a captured image acquiring means for acquiring a captured image obtained via an imaging sensor having an angle of view within which the target object lies; a generating means for generating, with reference to first two-dimensional data and third two-dimensional data, one or more candidate solutions regarding at least one selected from the group consisting of a position and an attitude of the target object in a three-dimensional space, the first two-dimensional data being obtained through a first feature extracting process in which the depth information is referred to, the third two-dimensional data being obtained through a first feature extracting process in which an image resulting from mapping of a three-dimensional model regarding the target object to a two-dimensional space is referred to; and a calculating means for calculating, with reference to second two-dimensional data and fourth two-dimensional data and with use of the one or more candidate solutions, at least one selected from the group consisting of the position and the attitude of the target object in the three-dimensional space, the second two-dimensional data being obtained through a second feature extracting process in which the captured image is referred to, the fourth two-dimensional data being obtained through a second feature extracting process in which an image resulting from mapping of the three-dimensional model regarding the target object to the two-dimensional space is referred to.

A recording medium in accordance with an example aspect of the present invention is a computer-readable recording medium having recorded thereon a program for causing a computer to function as: a depth information acquiring means for acquiring depth information obtained via a depth sensor having a sensing range within which a target object lies; a captured image acquiring means for acquiring a captured image obtained via an imaging sensor having an angle of view within which the target object lies; a first matching means for performing a first matching process in which first two-dimensional data and third two-dimensional data are referred to, the first two-dimensional data being obtained through a first feature extracting process in which the depth information is referred to, the third two-dimensional data being obtained through a first feature extracting process in which an image resulting from mapping of a three-dimensional model regarding the target object to a two-dimensional space is referred to; a second matching means for performing a second matching process in which second two-dimensional data and fourth two-dimensional data are referred to, the second two-dimensional data being obtained through a second feature extracting process in which the captured image is referred to, the fourth two-dimensional data being obtained through a second feature extracting process in which an image resulting from mapping of the three-dimensional model regarding the target object to the two-dimensional space is referred to; and a calculating means for calculating at least one selected from the group consisting of a position and an attitude of the target object in the three-dimensional space, with reference to a result of the first matching process and a result of the second matching process.

An information processing apparatus in accordance with an example aspect of the present invention includes: a depth information acquiring means for acquiring depth information obtained via a depth sensor having a sensing range within which a target object lies; a captured image acquiring means for acquiring a captured image obtained via an imaging sensor having an angle of view within which the target object lies; a generating means for generating, with reference to first two-dimensional data and a three-dimensional model regarding the target object, one or more candidate solutions regarding at least one selected from the group consisting of a position and an attitude of the target object in a three-dimensional space, the first two-dimensional data being obtained through a first feature extracting process in which the depth information is referred to; and a calculating means for calculating, with reference to second two-dimensional data and the three-dimensional model and with use of the one or more candidate solutions, at least one selected from the group consisting of the position and the attitude of the target object in the three-dimensional space, the second two-dimensional data being obtained through a second feature extracting process in which the captured image is referred to.

An information processing apparatus in accordance with an example aspect of the present invention includes: a depth information acquiring means for acquiring depth information obtained via a depth sensor having a sensing range within which a target object lies; a captured image acquiring means for acquiring a captured image obtained via an imaging sensor having an angle of view within which the target object lies; a first matching means for performing a first matching process in which first two-dimensional data and a three-dimensional model regarding the target object are referred to, the first two-dimensional data being obtained through a first feature extracting process in which the depth information is referred to; a second matching means for performing a second matching process in which second two-dimensional data and the three-dimensional model are referred to, the second two-dimensional data being obtained through a second feature extracting process in which the captured image is referred to; and a calculating means for calculating at least one selected from the group consisting of a position and an attitude of the target object in the three-dimensional space, with reference to a result of the first matching process and a result of the second matching process.

An information processing method in accordance with an example aspect of the present invention includes: acquiring depth information obtained via a depth sensor having a sensing range within which a target object lies; acquiring a captured image obtained via an imaging sensor having an angle of view within which the target object lies; a generating means for generating, with reference to first two-dimensional data and a three-dimensional model regarding the target object, one or more candidate solutions regarding at least one selected from the group consisting of a position and an attitude of the target object in a three-dimensional space, the first two-dimensional data being obtained through a first feature extracting process in which the depth information is referred to; and calculating, with reference to second two-dimensional data and the three-dimensional model and with use of the one or more candidate solutions, at least one selected from the group consisting of the position and the attitude of the target object in the three-dimensional space, the second two-dimensional data being obtained through a second feature extracting process in which the captured image is referred to.

An information processing method in accordance with an example aspect of the present invention includes: acquiring depth information obtained via a depth sensor having a sensing range within which a target object lies; acquiring a captured image obtained via an imaging sensor having an angle of view within which the target object lies; performing a first matching process in which first two-dimensional data and a three-dimensional model regarding the target object are referred to, the first two-dimensional data being obtained first feature extracting process in which the depth information is referred to; performing a second matching process in which second two-dimensional data and the three-dimensional model are referred to, the second two-dimensional data being obtained through a second feature extracting process in which the captured image is referred to; and calculating at least one selected from the group consisting of a position and an attitude of the target object in the three-dimensional space, with reference to a result of the first matching process and a result of the second matching process.

An information processing system in accordance with an example aspect of the present invention includes: a depth information acquiring means for acquiring depth information obtained via a depth sensor having a sensing range within which a target object lies; a captured image acquiring means for acquiring a captured image obtained via an imaging sensor having an angle of view within which the target object lies; a generating means for generating, with reference to first two-dimensional data and a three-dimensional model regarding the target object, one or more candidate solutions regarding at least one selected from the group consisting of a position and an attitude of the target object in a three-dimensional space, the first two-dimensional data being obtained through a first feature extracting process in which the depth information is referred to; and a calculating means for calculating, with reference to second two-dimensional data and the three-dimensional model and with use of the one or more candidate solutions, at least one selected from the group consisting of the position and the attitude of the target object in the three-dimensional space, the second two-dimensional data being obtained through a second feature extracting process in which the captured image is referred to.

An information processing system in accordance with an example aspect of the present invention includes: a depth information acquiring means for acquiring depth information obtained via a depth sensor having a sensing range within which a target object lies; a captured image acquiring means for acquiring a captured image obtained via an imaging sensor having an angle of view within which the target object lies; a first matching means for performing a first matching process in which first two-dimensional data and a three-dimensional model regarding the target object are referred to, the first two-dimensional data being obtained through a first feature extracting process in which the depth information is referred to; a second matching means for performing a second matching process in which second two-dimensional data and the three-dimensional model are referred to, the second two-dimensional data being obtained through a second feature extracting process in which the captured image is referred to; and a calculating means for calculating at least one selected from the group consisting of a position and an attitude of the target object in the three-dimensional space, with reference to a result of the first matching process and a result of the second matching process.

A recording medium in accordance with an example aspect of the present invention is a computer-readable recording medium having recorded thereon a program for causing a computer to function as: a depth information acquiring means for acquiring depth information obtained via a depth sensor having a sensing range within which a target object lies; a captured image acquiring means for acquiring a captured image obtained via an imaging sensor having an angle of view within which the target object lies; a generating means for generating, with reference to first two-dimensional data and a three-dimensional model regarding the target object, one or more candidate solutions regarding at least one selected from the group consisting of a position and an attitude of the target object in a three-dimensional space, the first two-dimensional data being obtained through a first feature extracting process in which the depth information is referred to; and a calculating means for calculating, with reference to second two-dimensional data and the three-dimensional model and with use of the one or more candidate solutions, at least one selected from the group consisting of the position and the attitude of the target object in the three-dimensional space, the second two-dimensional data being obtained through a second feature extracting process in which the captured image is referred to.

A recording medium in accordance with an example aspect of the present invention is a computer-readable recording medium having recorded thereon a program for causing a computer to function as: a depth information acquiring means for acquiring depth information obtained via a depth sensor having a sensing range within which a target object lies; a captured image acquiring means for acquiring a captured image obtained via an imaging sensor having an angle of view within which the target object lies; a first matching means for performing a first matching process in which first two-dimensional data and a three-dimensional model regarding the target object are referred to, the first two-dimensional data being obtained through a first feature extracting process in which the depth information is referred to; a second matching means for performing a second matching process in which second two-dimensional data and the three-dimensional model are referred to, the second two-dimensional data being obtained through a second feature extracting process in which the captured image is referred to; and a calculating means for calculating at least one selected from the group consisting of a position and an attitude of the target object in the three-dimensional space, with reference to a result of the first matching process and a result of the second matching process.

### Advantageous Effects of Invention

With an example aspect of the present invention, it is possible to suitably estimate at least one selected from the group consisting of the position and the attitude of a target object while reducing computational cost and computational time.

### BRIEF DESCRIPTION OF DRAWINGS

FIG. 1 is a block diagram illustrating a configuration of an information processing apparatus in accordance with a first example embodiment of the present invention.

FIG. 2 is a flowchart illustrating a flow of an information processing method in accordance with the first example embodiment of the present invention.

FIG. 3 is a block diagram illustrating a configuration of an information processing system in accordance with the first example embodiment of the present invention.

FIG. 4 is a block diagram illustrating a configuration of an information processing apparatus in accordance with a second example embodiment of the present invention.

FIG. 5 is a flowchart illustrating a flow of an information processing method in accordance with the second example embodiment of the present invention.

FIG. 6 is a block diagram illustrating a configuration of an information processing system in accordance with the second example embodiment of the present invention.

FIG. 7 is a block diagram illustrating a configuration of an information processing system in accordance with a third example embodiment of the present invention.

FIG. 8 is a diagram illustrating cameras for capturing a vessel of a truck which is a target object, and the positions of the cameras in the third example embodiment of the present invention.

FIG. 9 is a diagram illustrating a method whereby an RGB image position estimating section in accordance with the third example embodiment of the present invention calculates the position and the attitude of a target object in a three-dimensional space.

FIG. 10 is a flowchart illustrating a flow of processes performed by an information processing apparatus in accordance with the third example embodiment of the present invention.

FIG. 11 is a diagram illustrating an example of an image which is referred to or generated in each of the processes performed by the information processing apparatus in accordance with the third example embodiment of the present invention.

FIG. 12 is a block diagram illustrating a configuration of an information processing system in accordance with a fourth example embodiment of the present invention.

FIG. 13 is a block diagram illustrating a configuration of an information processing system in accordance with a fifth example embodiment of the present invention.

FIG. 14 is a flowchart illustrating a flow of processes performed by an information processing apparatus in accordance with the fifth example embodiment of the present invention.

FIG. 15 is a block diagram illustrating a configuration of an information processing system in accordance with a sixth example embodiment of the present invention.

FIG. 16 is a block diagram illustrating an example of a hardware configuration of the information processing apparatuses and the information processing systems in accordance with the example embodiments of the present invention.

### EXAMPLE EMBODIMENTS

### First Example Embodiment

The following description will discuss a first example embodiment of the present invention in detail, with reference to the drawings. The present example embodiment is basic to example embodiments which will be described later.

### (Configuration of Information Processing Apparatus 1)

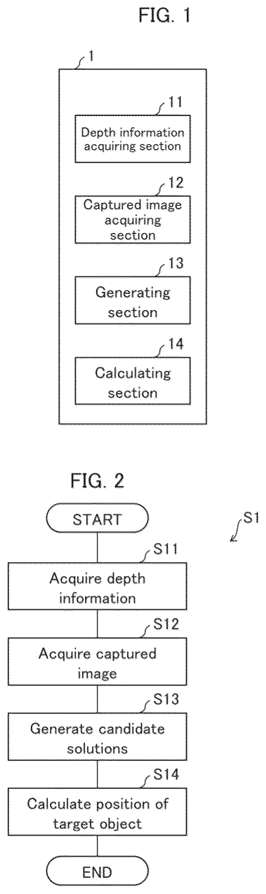

A configuration of an information processing apparatus 1 in accordance with the present example embodiment will be described below with reference to FIG. 1. FIG. 1 is a block diagram illustrating a configuration of an information processing apparatus 1 in accordance with the present example embodiment.

The information processing apparatus 1 calculates, with reference to depth information and a captured image, at least one selected from the group consisting of the position and the attitude of a target object, the depth information being obtained via a depth sensor having a sensing range within which the target object lies, the captured image being obtained via an imaging sensor having an angle of view within which the target object lies.

Examples of the target object include, but are not limited to, a vessel (loading platform) of a dump truck and a box capable of housing things in the interior thereof surrounded by an edge.

The information processing apparatus 1 can be widely applied to one or more automatic guided vehicles (AGVs), construction machines, self-driving vehicles, monitoring systems, etc. For example, the information processing apparatus 1 can be used in a system in a work site where earth excavated by a backhoe is loaded onto the vessel of a dump truck, the system being for calculating at least one selected from the group consisting of the position and the attitude of the vessel, which is the target object, of the dump truck and loading the earth onto the vessel with reference to the at least one selected from the group consisting of the position and the attitude calculated.

Examples of the depth sensor include, but are not limited to, a stereo camera and a light detection and ranging (LiDAR). The stereo camera includes a plurality of cameras, and uses parallax between the cameras to determine a distance (depth) to a target object. The LiDAR uses laser light to measure a distance (depth) to a target object. Examples of the depth information include a depth image and coordinate data. The depth image represents a depth acquired via the stereo camera. The coordinate data indicates the coordinates of each point acquired via the LiDAR. Note, however, that the present example embodiment is not limited thereto. Incidentally, by converting the coordinate data acquired via the LiDAR, it is possible to express a depth in the form of an image.

In the present example embodiment, the position of the target object is the position of the target object in a three-dimensional space, and is a concept including the translational position of the target object. The attitude of the target object is the attitude of the target object in the three-dimensional space, and is a concept t including the orientation of the target object. Note, however, that the present example embodiment is not limited to what parameter to specifically use to express the position and the attitude of the target object.

As an example, the position of the target object can be expressed by the position of the center of gravity of the target object (x, y, z), and the attitude of the target object can be expressed by the orientation of the target object (roll, pitch, yaw). In this case, the position and the attitude of the target object are expressed by six parameters (x, y, z, roll, pitch, and yaw).

The information processing apparatus 1 includes a depth information acquiring section 11, a captured image acquiring section 12, a generating section 13, and a calculating section 14, as illustrated in FIG. 1. The depth information acquiring section 11, the captured image acquiring section 12, the generating section 13, and the calculating section 14 implement the depth information acquiring means, the captured image acquiring means, the generating means, and the calculating means, respectively, in the present example embodiment.

The depth information acquiring section 11 acquires depth information obtained via a depth sensor having a sensing range within which a target object lies. The depth information acquiring section 11 supplies the generating section 13 with the depth information acquired.

The captured image acquiring section 12 acquires a captured image obtained via an imaging sensor having an angle of view within which the target object lies. The captured image acquiring section 12 supplies the calculating section 14 with the captured image acquired.

The generating section 13 generates, with reference to first two-dimensional data and a three-dimensional model regarding the target object, one or more candidate solutions regarding at least one selected from the group consisting of the position and the attitude of the target object in the three-dimensional space, the first two-dimensional data being obtained through a first feature extracting process in which the depth information supplied by the depth information acquiring section 11 is referred to. As an example, the generating section 13 refers to first two-dimensional data and third two-dimensional data, to generate one or more candidate solutions regarding at least one selected from the group consisting of the position and the attitude of the target object in the three-dimensional space, the first two-dimensional data being obtained through a first feature extracting process in which the depth information is referred to, the third two-dimensional data being obtained through a first feature extracting process in which an image resulting from mapping of the three-dimensional model regarding the target object to a two-dimensional space is referred to. The generating section 13 supplies the calculating section 14 with the one or more candidate solutions generated.

As used herein, the first feature extracting process means a process of referring to depth information to extract one or more features contained in the depth information. Examples of the first feature extracting process include an edge extracting process of extracting the edge of a target object with use of an edge extraction filter. With this configuration, it is possible to perform the edge extracting process on depth information. This enables the information processing apparatus 1 to suitably extract a feature of a target object.

Further, the three-dimensional model regarding the target object is a model which contains data expressing the size and shape of a target object in the three-dimensional space, and examples thereof include three-dimensional data which is a point data set representing the points contained in the target object.

The calculating section 14 refers to second two-dimensional data and the three-dimensional model regarding the target object, to calculate at least one selected from the group consisting of the position and the attitude of the target object in the three-dimensional space with use of the one or more candidate solutions generated by the generating section 13, the second two-dimensional data being obtained through a second feature extracting process in which the captured image supplied by the captured image acquiring section 12 is referred to. As an example, the calculating section 14 refers to second two-dimensional data and fourth two-dimensional data and uses the one or more candidate solutions generated by the generating section 13, to calculate at least one selected from the group consisting of the position and the attitude of the target object in the three-dimensional space, the second two-dimensional data being obtained through a second feature extracting process in which the captured image is referred to, the fourth two-dimensional data being obtained through a second feature extracting process in which an image resulting from mapping of the three-dimensional model regarding the target object to a two-dimensional space is referred to.

As used herein, the second feature extracting process means a process of referring to a captured image to extract one or more features contained in the captured image. Examples of the second feature extracting process include an edge extracting process of extracting the edge of a target object with use of an edge extraction filter. With this configuration, it is possible to perform the edge extracting process on a captured image. This enables the information processing apparatus 1 to suitably extract a feature of a target object.

The edge extraction filter used in the second feature extracting process may be the same as the edge extraction filter used in the first feature extracting process, or may be different from the edge extraction filter used in the first feature extracting process. For example, the edge extraction filter used in the second feature extracting process may be a filter having a filter coefficient different from that of the edge extraction filter used in the first feature extracting process.

As above, the configuration in which a depth information acquiring section 11, a captured image acquiring section 12, a generating section 13, and a calculating section 14 are included is employed in the information processing apparatus 1 in accordance with the present example embodiment, the depth information acquiring section 11 acquiring depth information obtained via a depth sensor having a sensing range within which a target object lies, the captured image acquiring section 12 acquiring a captured image obtained via an imaging sensor having an angle of view within which the target object lies, the generating section 13 generating, with reference to first two-dimensional data and a three-dimensional model regarding the target object, one or more candidate solutions regarding at least one selected from the group consisting of the position and the attitude of the target object in a three-dimensional space, the first two-dimensional data being obtained through a first feature extracting process in which the depth information is referred to, the calculating section 14 calculating, with reference to second two-dimensional data and a three-dimensional model regarding the target object and with use of the one or more candidate solutions, at least one selected from the group consisting of the position and the attitude of the target object in the three-dimensional space, the second two-dimensional data being obtained through a second feature extracting process in which the captured image is referred to.

More specifically, the configuration in which a depth information acquiring section 11, a captured image acquiring section 12, a generating section 13, and a calculating section 14 are included is employed in the information processing apparatus 1 in accordance with the present example embodiment, the depth information acquiring section 11 acquiring depth information obtained via a depth sensor having a sensing range within which a target object lies, the captured image acquiring section 12 acquiring a captured image obtained via an imaging sensor having an angle of view within which the target object lies, the generating section 13 generating, with reference to first two-dimensional data and third two-dimensional data, one or more candidate solutions regarding at least one selected from the group consisting of the position and the attitude of the target object in a three-dimensional space, the first two-dimensional data being obtained through a first feature extracting process in which the depth information is referred to, the third two-dimensional data being obtained through a first feature extracting process in which an image resulting from mapping of the three-dimensional model regarding the target object to a two-dimensional space is referred to, the calculating section 14 calculating, with reference to second two-dimensional data and fourth two-dimensional data and with use of the one or more candidate solutions, at least one selected from the group consisting of the position and the attitude of the target object in the three-dimensional space, the second two-dimensional data being obtained through the second feature extracting process in which the captured image is referred to, the fourth two-dimensional data being obtained through the second feature extracting process in which an image resulting from mapping of the three-dimensional model regarding the target object to the two-dimensional space is referred to.

As a result, with the information processing apparatus 1 in accordance with the present example embodiment, one or more candidate solutions regarding at least one selected from the group consisting of the position and the attitude of the target object in the three-dimensional space are generated with reference to the first two-dimensional data obtained with reference to depth information smaller in the amount of information than a captured image, and it is therefore possible to derive the one or more candidate solutions regarding at least one selected from the group consisting of the position and the attitude of the target object in the three-dimensional space while reducing, compared with the case of referring to the second two-dimensional data obtained with reference to a captured image, computational cost and computational time.

In addition, with the information processing apparatus 1 in accordance with the present example embodiment, at least one selected from the group consisting of the position and the attitude of a target object in a three-dimensional space is calculated with reference to the second two-dimensional data obtained with reference to a captured image greater in the amount of information than depth information and with use of the one or more candidate solutions. Thus, with the information processing apparatus 1 in accordance with the present example embodiment, it is possible to calculate at least one selected from the group consisting of the position and the attitude of the target object in the three-dimensional space with a higher degree of precision than in a case of using the first two-dimensional data obtained with reference to depth information. Furthermore, with the information processing apparatus 1 in accordance with the present example embodiment, it is possible to reduce, compared with in a case of not using a candidate solution, computational cost and computational time by using the one or more candidate solutions.

Thus, with the information processing apparatus 1 in accordance with the present example embodiment, it is possible to suitably estimate at least one selected from the group consisting of the position and the attitude of a target object while reducing computational cost and computational time.

### (Flow of Information Processing Method S1)

A flow of an information processing method S1 in accordance with the present example embodiment will be described below with reference to FIG. 2. FIG. 2 is a flowchart illustrating a flow of the information processing method S1 in accordance with the present example embodiment.

### (Step S11)

In step S11, the depth information acquiring section 11 acquires depth information obtained via a depth sensor having a sensing range within which a target object lies. The depth information acquiring section 11 supplies the generating section 13 with the depth information acquired.

### (Step S12)

In step S12, the captured image acquiring section 12 acquires a captured image obtained via an imaging sensor having an angle of view within which the target object lies. The captured image acquiring section 12 supplies the calculating section 14 with the captured image acquired.

### (Step S13)

In step S13, the generating section 13 generates, with reference to first two-dimensional data and a three-dimensional model regarding the target object, one or more candidate solutions regarding at least one selected from the group consisting of the position and the attitude of the target object in a three-dimensional space, the first two-dimensional data being obtained through a first feature extracting process in which the depth information supplied by the depth information acquiring section 11 in the step S11 is referred to. As an example, the generating section 13 refers to first two-dimensional data and third two-dimensional data, to generate one or more candidate solutions regarding at least one selected from the group consisting of the position and the attitude of the target object in the three-dimensional space, the first two-dimensional data being obtained through a first feature extracting process in which the depth information is referred to, the third two-dimensional data being obtained through a first feature extracting process in which an image resulting from mapping of the three-dimensional model regarding the target object to a two-dimensional space is referred to. The generating section 13 supplies the calculating section 14 with the one or more candidate solutions generated.

### (Step S14)

In step S14, the calculating section 14 calculates second two-dimensional data obtained through a second feature extracting process in which the captured image supplied by the captured image acquiring section 12 in the step S12 is referred to. In addition, the calculating section 14 calculates, with reference to the second two-dimensional data and the three-dimensional model and with use of the one or more candidate solutions supplied by the generating section 13 in the step S13, at least one selected from the group consisting of the position and the attitude of the target object in the three-dimensional space. As an example, the calculating section 14 refers to second two-dimensional data and fourth two-dimensional data and uses the one or more candidate solutions supplied by the generating section 13, to calculate at least one selected from the group consisting of the position and the attitude of the target object in the three-dimensional space, the two-dimensional data being obtained through a second feature extracting process in which the captured image is referred to, the fourth two-dimensional data being obtained through a second feature extracting process in which an image resulting from mapping of the three-dimensional model regarding the target object to a two-dimensional space is referred to.

As above, in the information processing method S1 in accordance with the present example embodiment, in the step S11, the depth information acquiring section 11 acquires depth information obtained via a depth sensor having a sensing range within which a target object lies, and in the step S12, the captured image acquiring section 12 acquires a captured image obtained via an imaging sensor having an angle of view within which the target object lies. Further, in the information processing method S1 in accordance with the present example embodiment, in the step S13, the generating section 13 generates, with reference to first two-dimensional data and a three-dimensional model regarding the target object, one or more candidate solutions regarding at least one selected from the group consisting of the position and the attitude of the target object in a three-dimensional space, the first two-dimensional data being obtained through a first feature extracting process in which the depth information is referred to. Furthermore, in the information processing method S1 in accordance with the present example embodiment, in the step S14, the calculating section 14 calculates, with reference to second two-dimensional data and the three-dimensional model regarding the target object and with use of the one or more candidate solutions, at least one selected from the group consisting of the position and the attitude of the target object in the three-dimensional space, the second two-dimensional data being obtained through a second feature extracting process in which the captured image is referred to.

More specifically, in the information processing method S1 in accordance with the present example embodiment, in the step S11, the depth information acquiring section 11 acquires depth information obtained via a depth sensor having a sensing range within which a target object lies, and in the step S12, the captured image acquiring section 12 acquires a captured image obtained via an imaging sensor having an angle of view within which the target object lies. Further, in the information processing method S1 in accordance with the present example embodiment, in the step S13, the generating section 13 generates, with reference to first two-dimensional data and third two-dimensional data, one or more candidate solutions regarding at least one selected from the group consisting of the position and the attitude of the target object in a three-dimensional space, the first two-dimensional data being obtained through a first feature extracting process in which the depth information is referred to, the third two-dimensional data being obtained through a first feature extracting process in which an image resulting from mapping of a three-dimensional model regarding the target object to a two-dimensional space is referred to. Furthermore, in the information processing method S1 in accordance with the present example embodiment, in the step S14, the calculating section 14 calculates, with reference to second two-dimensional data and fourth two-dimensional data and with use of the one or more candidate solutions, at least one selected from the group consisting of the position and the attitude of the target object in the three-dimensional space, the second two-dimensional data being obtained through a second feature extracting process in which the captured image is referred to, the fourth two-dimensional data being obtained through a second feature extracting process in which an image resulting from mapping of the three-dimensional model regarding the target object to the two-dimensional space is referred to.

Thus, the information processing method S1 in accordance with the present example embodiment provides the same example advantage as the information processing apparatus 1.

### (Configuration of Information Processing System 10)

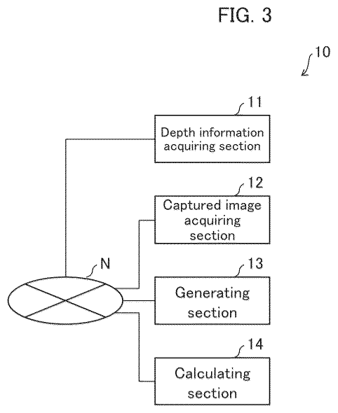

A configuration of an information processing system 10 in accordance with the present example embodiment will be described below with reference to FIG. 3. FIG. 3 is a block diagram illustrating a configuration of the information processing system 10 in accordance with the present example embodiment.

The information processing system 10 includes the depth information acquiring section 11, the captured image acquiring section 12, the generating section 13, and the calculating section 14, as illustrated in FIG. 3. Further, in the information processing system 10, the depth information acquiring section 11, the captured image acquiring section 12, the generating section 13, and the calculating section 14 are communicably connected with each other via a network N, as illustrated in FIG. 3.

The present example embodiment is not limited to a specific configuration of the network N. As an example, the network N is, for example, a wireless local area network (LAN), a wired LAN, a wide area network (WAN), a public network, a mobile data communication network, or a combination thereof.

The depth information acquiring section 11 acquires depth information obtained via a depth sensor having a sensing range within which a target object lies. The depth information acquiring section 11 outputs the acquired depth information to the generating section 13 via the network N.

The captured image acquiring section 12 acquires a captured image obtained via an imaging sensor having an angle of view within which the target object lies. The captured image acquiring section 12 outputs the acquired captured image to the calculating section 14 via the network N.

The generating section 13 generates, with reference to first two-dimensional data and a three-dimensional model regarding the target object, one or more candidate solutions regarding at least one selected from the group consisting of the position and the attitude of the target object in the three-dimensional space, the first two-dimensional data being obtained through a first feature extracting process in which the depth information outputted by the depth information acquiring section 11 is referred to. As an example, the generating section 13 refers to first two-dimensional data and third two-dimensional data, to generate one or more candidate solutions regarding at least one selected from the group consisting of the position and the attitude of the target object in the three-dimensional space, the first two-dimensional data being obtained through a first feature extracting process in which the depth information is referred to, the third two-dimensional data being obtained through a first feature extracting process in which an image resulting from mapping of the three-dimensional model regarding the target object to a two-dimensional space is referred to. The generating section 13 outputs the generated one or more candidate solutions to the calculating section 14 via the network N.

The calculating section 14 calculates, with reference to second two-dimensional data and the three-dimensional model regarding the target object and with use of the one or more candidate solutions outputted by the generating section 13, at least one selected from the group consisting of the position and the attitude of the target object in the three-dimensional space, the second two-dimensional data being obtained through a second feature extracting process in which the captured image outputted by the captured image acquiring section 12 is referred to. As an example, the calculating section 14 refers to second two-dimensional data and fourth two-dimensional data and uses the one or more candidate solutions generated by the generating section 13, to calculate at least one selected from the group consisting of the position and the attitude of the target object in the three-dimensional space, the two-dimensional data being obtained through a second feature extracting process in which the captured image is referred to, the fourth two-dimensional data being obtained through a second feature extracting process in which an image resulting from mapping of the three-dimensional model regarding the target object to a two-dimensional space is referred to.

As above, the configuration in which a depth information acquiring section 11, a captured image acquiring section 12, a generating section 13, and a calculating section 14 are included is employed in the information processing system 10 in accordance with the present example embodiment, the depth information acquiring section 11 acquiring depth information obtained via a depth sensor having a sensing range within which a target object lies, the captured image acquiring section 12 acquiring a captured image obtained via an imaging sensor having an angle of view within which the target object lies, the generating section 13 generating, with reference to first two-dimensional data and a three-dimensional model regarding the target object, one or more candidate solutions regarding at least one selected from the group consisting of the position and the attitude of the target object in a three-dimensional space, the first two-dimensional data being obtained through a first feature extracting process in which the depth information is referred to, the calculating section 14 calculating, with reference to second two-dimensional data and the three-dimensional model regarding the target object and with use of the one or more candidate solutions, at least one selected from the group consisting of the position and the attitude of the target object in the three-dimensional space, the second two-dimensional data being obtained through a second feature extracting process in which the captured image is referred to.

More specifically, the configuration in which a depth information acquiring section 11, a captured image acquiring section 12, a generating section 13, and a calculating section 14 are included is employed in the information processing system 10 in accordance with the present example embodiment, the depth information acquiring section 11 acquiring depth information obtained via a depth sensor having a sensing range within which a target object lies, the captured image acquiring section 12 acquiring captured image obtained via an imaging sensor having an angle of view within which the target object lies, the generating section 13 generating, with reference to first two-dimensional data and third two-dimensional data, one or more candidate solutions regarding at least one selected from the group consisting of the position and the attitude of the target object in the three-dimensional space, the first two-dimensional data being obtained through a first feature extracting process in which the depth information is referred to, the third two-dimensional data being obtained through a first feature extracting process in which an image resulting from mapping of the three-dimensional model regarding the target object to a two-dimensional space is referred to, the calculating section 14 calculating, with reference to second two-dimensional data and fourth two-dimensional data and with use of the one or more candidate solutions, at least one selected from the group consisting of the position and the attitude of the target object in the three-dimensional space, the second two-dimensional data being obtained through a second feature extracting process in which the captured image is referred to, the fourth two-dimensional data being obtained through a second feature extracting process in which an image resulting from mapping of the three-dimensional model regarding the target object to the two-dimensional space is referred to.

Thus, the information processing system 10 in accordance with the present example embodiment provides the same example advantage as the information processing apparatus 1.

### Second Example Embodiment

The following description will discuss a second example embodiment of the present invention in detail, with reference to the drawings. A component that has the same function as a component described in the first example embodiment is assigned the same reference sign, and the description thereof is omitted where appropriate.

### (Configuration of Information Processing Apparatus 2)

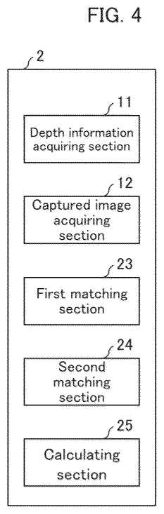

A configuration of an information processing apparatus 2 in accordance with the present example embodiment will be described below with reference to FIG. 4. FIG. 4 is a block diagram illustrating a configuration of the information processing apparatus 2 in accordance with the present example embodiment.

The information processing apparatus 2 calculates at least one selected from the group consisting of the position and the attitude of a target object, with reference to depth information and a captured image, the depth information being obtained via a depth sensor having a sensing range within which the target object lies, the captured image being obtained via an imaging sensor having an angle of view within which the target object lies. The target object, the depth information, and the position and the attitude of the target object are as described in the above example embodiment.

The information processing apparatus 2 includes a depth information acquiring section 11, a captured image acquiring section 12, a first matching section 23, a second matching section 24, and a calculating section 25, as illustrated in FIG. 4. The depth information acquiring section 11, the captured image acquiring section 12, the first matching section 23, the second matching section 24, and the calculating section 25 implement the depth information acquiring means, the captured image acquiring means, the first matching means, the second matching means, and the calculating means, respectively, in the present example embodiment.

The depth information acquiring section 11 acquires depth information obtained via a depth sensor having a sensing range within which a target object lies. The depth information acquiring section 11 supplies the first matching section 23 with the depth information acquired.

The captured image acquiring section 12 acquires a captured image obtained via an imaging sensor having an angle of view within which the target object lies. The captured image acquiring section 12 supplies the second matching section 24 with the captured image acquired.

The first matching section 23 performs a first matching process in which first two-dimensional data and a three-dimensional model regarding the target object are referred to, the first two-dimensional data being obtained through a first feature extracting process in which the depth information supplied by the depth information acquiring section 11 is referred to. As an example, the first matching section 23 performs a first matching process in which first two-dimensional data and third two-dimensional data are referred to, the first two-dimensional data being obtained through a first feature extracting process in which the depth information is referred to, the third two-dimensional data being obtained through a first feature extracting process in which an image resulting from mapping of a three-dimensional model regarding the target object to a two-dimensional space is referred to; The first feature extracting process is as described in the above example embodiment.

The first matching process is a process of referring to the first two-dimensional data and the three-dimensional model regarding the target object to judge whether the position of the target object contained in the first two-dimensional data matches the position of the target object indicated by the three-dimensional model. The first matching section 23 supplies the calculating section 25 with a result of the first matching process.

The second matching section 24 performs a second matching process in which second two-dimensional data and the three-dimensional model are referred to, the second two-dimensional data being obtained through a second feature extracting process in which the captured image supplied by the captured image acquiring section 12 is referred to. As an example, the second matching section 24 performs a second matching process in which second two-dimensional data and fourth two-dimensional data are referred to, the second two-dimensional data being obtained through a second feature extracting process in which the captured image is referred to, the fourth two-dimensional data being obtained through a second feature extracting process in which an image resulting from mapping of a three-dimensional model regarding the target object to a two-dimensional space is referred to. The second feature extracting process is as described in the above example embodiment.

The second matching process is a process of referring to the second two-dimensional data and the three-dimensional model regarding the target object to judge whether the position of the target object contained in the second two-dimensional data matches the position of the target object indicated by the three-dimensional model. The second matching section 24 supplies the calculating section 25 with a result of the second matching process.

The calculating section 25 calculates, with reference to the result of the first matching process supplied by the first matching section 23 and the result of the second matching process supplied by the second matching section 24, at least one selected from the group consisting of the position and the attitude of the target object in the three-dimensional space.

As above, the configuration in which a depth information acquiring section 11, a captured image acquiring section 12, a first matching section 23, a second matching section 24, and a calculating section 25 are included is employed in the information processing apparatus 2 in accordance with the present example embodiment, the depth information acquiring section acquiring depth 11 information obtained via a depth sensor having a sensing range within which a target object lies, the captured image acquiring section 12 acquiring a captured image obtained via an imaging sensor having an angle of view within which the target object lies, the first matching section 23 performing a first matching process in which first two-dimensional data and a three-dimensional model regarding the target object are referred to, the first two-dimensional data being obtained through a first feature extracting process in which the depth information is referred to, the second matching section 24 performing a second matching process in which second two-dimensional data and the three-dimensional model regarding the target object are referred to, the second two-dimensional data being obtained through a second feature extracting process in which the captured image is referred to, the calculating section 25 calculating, with reference to a result of the first matching process and a result of the second matching process, at least one selected from the group consisting of the position and the attitude of the target object in a three-dimensional space.

More specifically, the configuration in which a depth information acquiring section 11, a captured image acquiring section 12, a first matching section 23, a second matching section 24, and a calculating section 25 are included is employed in the information processing apparatus 2 in accordance with the present example embodiment, the depth information acquiring section 11 acquiring depth information obtained via a depth sensor having a sensing range within which a target object lies, the captured image acquiring section 12 acquiring a captured image obtained via an imaging sensor having an angle of view within which the target object lies, the first matching section 23 performing a first matching process in which first two-dimensional data and third two-dimensional data are referred to, the first two-dimensional data being obtained through a first feature extracting process in which the depth information is referred to, the third two-dimensional data being obtained through a first feature extracting process in which an image resulting from mapping of a three-dimensional model regarding the target object to a two-dimensional space is referred to, the second matching second matching section 24 performing a second matching process in which second two-dimensional data and fourth two-dimensional data are referred to, the second two-dimensional data being obtained through a second feature extracting process in which the captured image is referred to, the fourth two-dimensional data being obtained through a second feature extracting process in which an image resulting from mapping of the three-dimensional model regarding the target object to the two-dimensional space is referred to, the calculating section 25 calculating, with reference to a result of the first matching process and a result of the second matching process, at least one selected from the group consisting of the position and the attitude of the target object in a three-dimensional space.

As a result, with the information processing apparatus 2 in accordance with the present example embodiment, at least one selected from the group consisting of the position and the attitude of the target object in a three-dimensional space is calculated with reference to the result of the first matching process in which the first two-dimensional data obtained with reference to the depth information smaller in the amount of information than the captured image and the result of the second matching process in which the second two-dimensional data obtained with reference to the captured image greater in the amount of information than the depth information is referred to.

Thus, with the information processing apparatus 2 in accordance with the present example embodiment, it is possible to derive at least one selected from the group consisting of the position and the attitude of the target object in the three-dimensional space, the at least one selected from the group consisting of the position and the attitude being calculated with reference to the result of the first matching process in which the depth information smaller in the amount of information than the captured image is referred to, while reducing computational cost and computational time.

At the same time, with the information processing apparatus 2 in accordance with the present example embodiment, it is possible to calculate at least one selected from the group consisting of the position and the attitude of the target object in the three-dimensional space with a higher degree of precision, the at least one selected from the group consisting of the position and the attitude being calculated with reference to the result of the second matching process in which the captured image greater than the amount of information than the depth information is referred to. That is to say, with the information processing apparatus 2 in accordance with the present example embodiment, it is possible to suitably estimate at least one selected from the group consisting of the position and the attitude of a target object, while reducing computational cost and computational time.

### (Flow of Information Processing Method S1)

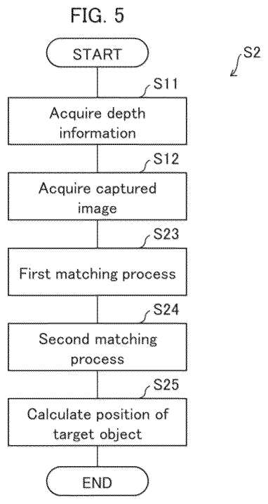

A flow of an information processing method S2 in accordance with the present example embodiment will be described below with reference to FIG. 5. FIG. 5 is a flowchart illustrating a flow of the information processing method S2 in accordance with the present example embodiment.

### (Step S11)

In step S11, the depth information acquiring section 11 acquires depth information obtained via a depth sensor having a sensing range within which a target object lies. The depth information acquiring section 11 supplies the generating section 13 with the depth information acquired.

### (Step S12)

In step S12, the captured image acquiring section 12 acquires a captured image obtained via an imaging sensor having an angle of view within which the target object lies. The captured image acquiring section 12 supplies the calculating section 14 with the captured image acquired.

### (Step S23)

In step S23, the first matching section 23 performs a first matching process in which first two-dimensional data and a three-dimensional model regarding the target object are referred to, the first two-dimensional data being obtained through a first feature extracting process in which the depth information supplied by the depth information acquiring section 11 in the step S11 is referred to. As an example, the first matching section 23 performs a first matching process in which first two-dimensional data and third two-dimensional data are referred to, the first two-dimensional data being obtained through a first feature extracting process in which the depth information is referred to, the third two-dimensional data being obtained through a first feature extracting process in which an image resulting from mapping of a three-dimensional model regarding the target object to a two-dimensional space is referred to; The first matching section 23 supplies the calculating section 25 with a result of the first matching process.

### (Step S24)

In step S24, the second matching section 24 performs a second matching process in which second two-dimensional data and the three-dimensional model are referred to, the second two-dimensional data being obtained through a second feature extracting process in which the captured image supplied by the captured image acquiring section 12 in the step S12 is referred to. As an example, the second matching section 24 performs a second matching process in which second two-dimensional data and fourth two-dimensional data are referred to, the second two-dimensional data being obtained through a second feature extracting process in which the captured image is referred to, the fourth two-dimensional data being obtained through a second feature extracting process in which an image resulting from mapping of a three-dimensional model regarding the target object to a two-dimensional space is referred to. The second matching section 24 supplies the calculating section 25 with a result of the second matching process.

### (Step S25)

In step S25, the calculating section 25 calculates, with reference to the result of the first matching process supplied by the first matching section 23 in the step S23 and the result of the second matching process supplied by the second matching section 24 in the step S24, at least one selected from the group consisting of the position and the attitude of the target object in the three-dimensional space.

As above, in the information processing method S2 in accordance with the present example embodiment, in the step S11, the depth information acquiring section 11 acquires depth information obtained via a depth sensor having a sensing range within which a target object lies, and in the step S12, the captured image acquiring section 12 acquires a captured image obtained via an imaging sensor having an angle of view within which the target object lies. Further, in the information processing method S2 in accordance with the present example embodiment, in the step S23, the first matching section 23 performs a first matching process in which first two-dimensional data and a three-dimensional model regarding the target object are referred to, the first two-dimensional data being obtained through a first feature extracting process in which the depth information is referred to, and in the step S24, the second matching section 24 performs a second matching process in which second two-dimensional data and the three-dimensional model regarding the target object are referred to, the second two-dimensional data being obtained through a second feature extracting process in which the captured image is referred to. Furthermore, in the information processing method S2 in accordance with the present example embodiment, in the step S25, the calculating section 25 calculates, with reference to a result of the first matching process and a result of the second matching process, at least one selected from the group consisting of the position and the attitude of the target object in the three-dimensional space.

More specifically, in the information processing method S2 in accordance with the present example embodiment, in the step S11, the depth information acquiring section 11 acquires depth information obtained via a depth sensor having a sensing range within which a target object lies, and in the step S12, the captured image acquiring section 12 acquires a captured image obtained via an imaging sensor having an angle of view within which the target object lies. Further, in the information processing method S2 in accordance with the present example embodiment, in the step S23, the first matching section 23 performs a first matching process in which first two-dimensional data and third two-dimensional data are referred to, the first two-dimensional data being obtained through a first feature extracting process in which the depth information is referred to, the third two-dimensional data being obtained through a first feature extracting process in which an image resulting from mapping of the three-dimensional model regarding the target object to a two-dimensional space is referred to, and in the step S24, the second matching section 24 performs a second matching process in which second two-dimensional data and fourth two-dimensional data are referred to, the second two-dimensional data being obtained through a second feature extracting process in which the captured image is referred to, the fourth two-dimensional data being obtained through a second feature extracting process in which an image resulting from mapping of the three-dimensional model regarding the target object to the two-dimensional space is referred to. Furthermore, in the information processing method S2 in accordance with the present example embodiment, in the step S25, the calculating section 25 calculates, with reference to a result of the first matching process and a result of the second matching process, at least one selected from the group consisting of the position and the attitude of the target object in the three-dimensional space.

Thus, the information processing method S2 in accordance with the present example embodiment provides the same example advantage as the information processing apparatus 2.

### (Configuration of Information Processing System 20)

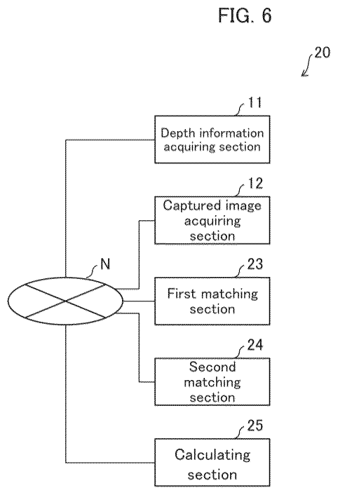

A configuration of an information processing system 20 in accordance with the present example embodiment will be described below with reference to FIG. 6. FIG. 6 is a block diagram illustrating a configuration of the information processing system 20 in accordance with the present example embodiment.

The information processing system 20 includes the depth information acquiring section 11, the captured image acquiring section 12, the first matching section 23, the second matching section 24, and the calculating section 25, as illustrated in FIG. 6. In addition, in the information processing system 20, the depth information acquiring section 11, the captured image acquiring section 12, the first matching section 23, the second matching section 24, and the calculating section 25 are communicably connected with each other via a network N, as illustrated in FIG. 6. The network N is as described in the above example embodiment.

The depth information acquiring section 11 acquires depth information obtained via a depth sensor having a sensing range within which a target object lies. The depth information acquiring section 11 outputs the acquired depth information to the first matching section 23 via the network N.

The captured image acquiring section 12 acquires a captured image obtained via an imaging sensor having an angle of view within which the target object lies. The captured image acquiring section 12 outputs the acquired captured image to the second matching section 24 via the network N.

The first matching section 23 performs a first matching process in which first two-dimensional data and a three-dimensional model regarding the target object are referred to, the first two-dimensional data being obtained through a first feature extracting process in which the depth information outputted by the depth information acquiring section 11 is referred to. As an example, the first matching section 23 performs a first matching process in which first two-dimensional data and third two-dimensional data are referred to, the first two-dimensional data being obtained through a first feature extracting process in which the depth information is referred to, the third two-dimensional data being obtained through a first feature extracting process in which an image resulting from mapping of a three-dimensional model regarding the target object to a two-dimensional space is referred to; The first matching section 23 outputs a result of the first matching process to the calculating section 25 via the network N.

The second matching section 24 performs a second matching process in which second two-dimensional data and the three-dimensional model are referred to, the second two-dimensional data being obtained through a second feature extracting process in which the captured image outputted by the captured image acquiring section 12 is referred to. As an example, the second matching section 24 performs a second matching process in which second two-dimensional data and fourth two-dimensional data are referred to, the second two-dimensional data being obtained through a second feature extracting process in which the captured image is referred to, the fourth two-dimensional data being obtained through a second feature extracting process in which an image resulting from mapping of a three-dimensional model regarding the target object to a two-dimensional space is referred to. The second matching section 24 outputs a result of the second matching process to the calculating section 25 via the network N.

The calculating section 25 calculates, with reference to the result of the first matching process outputted by the first matching section 23 and the result of the second matching process outputted by the second matching section 24, at least one selected from the group consisting of the position and the attitude of the target object in the three-dimensional space.

As above, the information processing system 20 in accordance with the present example embodiment includes a depth information acquiring section 11, a captured image acquiring section 12, a first matching section 23, a second matching section 24, and a calculating section 25 are included, the depth information acquiring section 11 acquiring depth information obtained via a depth sensor having a sensing range within which a target object lies, the captured image acquiring section 12 acquiring a captured image obtained via an imaging sensor having an angle of view within which the target object lies, the first matching section 23 performing a first matching process in which first two-dimensional data and a three-dimensional model regarding the target object are referred to, the first two-dimensional data being obtained through a first feature extracting process in which the depth information is referred to, the second matching section 24 performing a second matching process in which second two-dimensional data and the three-dimensional model regarding the target object are referred to, the second two-dimensional data being obtained through a second feature extracting process in which the captured image is referred to, the calculating section 25 calculating, with reference to a result of the first matching process and a result of the second matching process, at least one selected from the group consisting of the position and the attitude of the target object in a three-dimensional space.

More specifically, the configuration in which a depth information acquiring section 11, a captured image acquiring section 12, a first matching section 23, a second matching section 24, and a calculating section 25 are included is employed in the information processing system 20 in accordance with the present example embodiment, the depth information acquiring section 11 acquiring depth information obtained via a depth sensor having a sensing range within which a target object lies, the captured image acquiring section 12 acquiring a captured image obtained via an imaging sensor having an angle of view within which the target object lies, the first matching section 23 performing a first matching process in which first two-dimensional data and third two-dimensional data are referred to, the first two-dimensional data being obtained through a first feature extracting process in which the depth information is referred to, the third two-dimensional data being obtained through a first feature extracting process in which an image resulting from mapping of a three-dimensional model regarding the target object to a two-dimensional space is referred to, the second matching second matching section 24 performing a second matching process in which second two-dimensional data and fourth two-dimensional data are referred to, the second two-dimensional data being obtained through a second feature extracting process in which the captured image is referred to, the fourth two-dimensional data being obtained through a second feature extracting process in which an image resulting from mapping of the three-dimensional model regarding the target object to the two-dimensional space is referred to, the calculating section 25 calculating, with reference to a result of the first matching process and a result of the second matching process, at least one selected from the group consisting of the position and the attitude of the target object in a three-dimensional space.

Thus, the information processing system 20 in accordance with the present example embodiment provides the same example advantage as the information processing apparatus 2.

### Third Example Embodiment

The following description will discuss a third example embodiment of the present invention in detail, with reference to the drawings. A component which has the same function as the component described in the above example embodiments is assigned the same reference, and the description thereof is not repeated.

### (Configuration of Information Processing System 100)

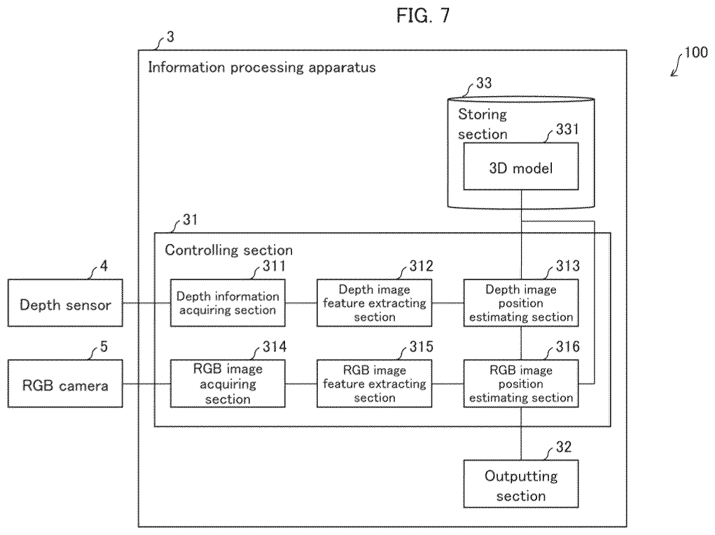

A configuration of an information processing system 100 in accordance with the present example embodiment will be described below with reference to FIG. 7. FIG. 7 is a block diagram illustrating a configuration of the information processing system 100 in accordance with the present example embodiment.

The information processing system 100 includes an information processing apparatus 3, a depth sensor 4, and an RGB (Red, Green, Blue) camera 5, as illustrated in FIG. 7. In the information processing system 100, the information processing apparatus 3 acquires depth information obtained via the depth sensor 4 with a target object lying within the sensing range, and acquires captured image information obtained via the RGB camera 5 with the target object lying within the angle of view. The information processing apparatus 3 then calculates at least one selected from the group consisting of the position and the attitude of the target object, with reference to the depth information and the captured image information acquired. The target object, the depth information, and the position and the attitude of the target object are as described in the above example embodiments.

The depth sensor 4 outputs depth information which indicates a distance to a physical body which lies within the sensing range thereof. Examples of the depth sensor 4 include, but are not limited to, a stereo camera including a plurality of cameras and a LiDAR, as described in the above example embodiments. Similarly, examples of the depth information include, but are not limited to, a depth image representing a depth and a coordinate data indicating the coordinates of each point, as described in the above example embodiments.

The RGB camera 5 includes an imaging sensor which images a physical body which lies within the angle of view thereof, and outputs captured image data obtained with the physical body lying within the angle of view. The configuration of the information processing system 100 only needs to include a camera which is not limited to the RGB camera 5 but is a camera that outputs a multivalued image, and may be, for example, a configuration in which a monochrome camera is included instead of the RGB camera 5, the monochrome camera outputting a black-and-white image in which a captured physical body is expressed in the shades of grey from white to black.

### (Configuration of Information Processing Apparatus 3)

The information processing apparatus 3 includes a controlling section 31, an outputting section 32, and a storing section 33, as illustrated in FIG. 7.

The outputting section 32 is a device which outputs data supplied by the controlling section 31, which will be described later. As an example of a configuration in which the outputting section 32 outputs data, the outputting section 32 is connected to a network (not illustrated), and outputs data to another apparatus with which the outputting section 32 is communicable via the network. As another example of the configuration in which the outputting section 32 outputs data, the outputting section 32 is connected to a display (e.g., a display panel) which is not illustrated, and outputs data which indicates an image to be presented on the display. The present example embodiment is not limited to these examples.

In the storing section 33, various kinds of data to which the controlling section 31, which will be described later, refers are stored. As an example, a 3D model 331, which is a three-dimensional model regarding the target object, is stored in the storing section 33. The 3D model 331 may be defined by meshes or surfaces used in 3D modeling, may be a model which explicitly contains data on the edge (outline) of a target object, or the texture of the 3D model 331, the texture indicating features of the image of the target object, may be defined. The configuration in which the 3D model 331 explicitly contains data on the edge (outline) of a target object makes it possible to perform an edge extracting process on the 3D model 331. This enables the information processing apparatus 3 to suitably extract a feature of the target object. In addition, the 3D model 331 may contain data on the vertices of the target object. The three-dimensional model regarding the target object is as described in the above example embodiments.

### (Controlling Section 31)

The controlling section 31 controls the components of the information processing apparatus 3. As an example, the controlling section 31 acquires data from the storing section 33, and outputs data to the outputting section 32. The controlling section 31 also functions as a depth information acquiring section 311, a depth image feature extracting section 312, a depth image position estimating section 313, an RGB image acquiring section 314, an RGB image feature extracting section 315, and an RGB image position estimating section 316, as illustrated in FIG. 7. The depth information acquiring section 311, the depth image position estimating section 313, the RGB image acquiring section 314, and the RGB image position estimating section 316 implement the depth information acquiring means, the generating means, the captured image acquiring means, and the calculating means, respectively, in the present example embodiment.

The depth information acquiring section 311 acquires depth information obtained via the depth sensor 4 having a sensing range within which a target object lies. Further, the depth information acquiring section 311 acquires depth information in the sensing range, the depth information being obtained via the depth sensor 4, even in a case where the target object is not present within the sensing range. The depth information acquiring section 311 supplies the depth image feature extracting section 312 with the depth information acquired.

The depth image feature extracting section 312 performs a first feature extracting process in which the depth information supplied by the depth information acquiring section 311 is referred to, to generate first two-dimensional data. The depth image feature extracting section 312 supplies the depth image position estimating section 313 with the first two-dimensional data generated. The first feature extracting process is as described in the above example embodiment. An example of a process performed by the depth image feature extracting section 312 will be described later with reference to another drawing.

The depth image position estimating section 313 refers to the first two-dimensional data supplied by the depth image feature extracting section 312 and the 3D model 331 stored in the storing section 33, to generate one or more candidate solutions regarding at least one selected from the group consisting of the position and the attitude of the target object in the three-dimensional space. The depth image position estimating section 313 supplies the RGB image position estimating section 316 with the one or more candidate solutions generated. An example of a process performed by the depth image position estimating section 313 will be described later with reference to another drawing.

The RGB image acquiring section 314 acquires an RGB image (captured image) obtained via the RGB camera 5 having an angle of view within which the target object lies. The RGB image acquiring section 314 supplies the RGB image feature extracting section 315 with the RGB image acquired.

The RGB image feature extracting section 315 performs a second feature extracting process in which the RGB image supplied by the RGB image acquiring section 314 is referred to, to generate second two-dimensional data. The RGB image feature extracting section 315 supplies the RGB image position estimating section 316 with the second two-dimensional data generated. The second feature extracting process is as described in the above example embodiments. An example of a process performed by the RGB image feature extracting section 315 will be described later with reference to another drawing.

The RGB image position estimating section 316 refers to the second two-dimensional data supplied by the RGB image feature extracting section 315 and the 3D model 331 stored in the storing section 33, and uses the one or more candidate solutions supplied by the depth image position estimating section 313, to calculate at least one selected from the group consisting of the position and the attitude of the target object in the three-dimensional space. The RGB image position estimating section 316 supplies the outputting section 32 with the at least one selected from the group consisting of the position and the attitude of the target object in the three-dimensional space calculated. An example of a process performed by the RGB image position estimating section 316 will be described later.

### (Example Method for Calculating Position and Attitude of Target Object in Three-Dimensional Space)

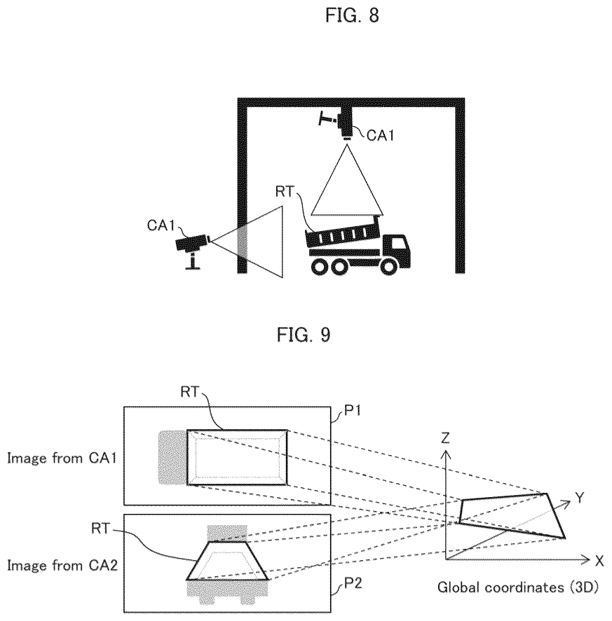

An example of a method whereby the RGB image position estimating section 316 calculates the position and the attitude of the target object in the three-dimensional space will be described below with use of FIGS. 8 and 9. FIG. 8 is a diagram illustrating the positions of a camera CA1 and a camera CA2 for capturing a vessel RT of a truck which is a target object in the present example embodiment. FIG. 9 is a diagram illustrating a method whereby the RGB image position estimating section 316 in accordance with the present example embodiment calculates the position and the attitude of the target object in the three-dimensional space.

For example, in a case where the target object RT is captured with use of the camera CA1 illustrated in FIG. 8, an image outputted by the camera CA1 is an image P1 illustrated in FIG. 9. The RGB image position estimating section 316 moves and rotates the 3D model on the basis of positional parameters, to calculate the position of the target object RT contained in the image P1 in the form of the coordinates of the target object RT (the position and the attitude of the target object RT in the three-dimensional space) in a global coordinate system.

The positional parameters express potential positions and attitudes of the target object RT. Examples of the positional parameters will be described later with reference to another drawing.

As another example, in a case where the target object RT is captured with use of the camera CA2 illustrated in FIG. 8, an image outputted by the camera CA2 is an image P2 illustrated in FIG. 9. The RGB image position estimating section 316 moves and rotates the 3D model on the basis of the positional parameters, to calculate the position of the target object RT contained in the image P2 in the form of the coordinates of the target object RT (the position and the attitude of the target object RT in the three-dimensional space) in a global coordinate system.

### (Flow of Processes Performed by Information Processing Apparatus 3)

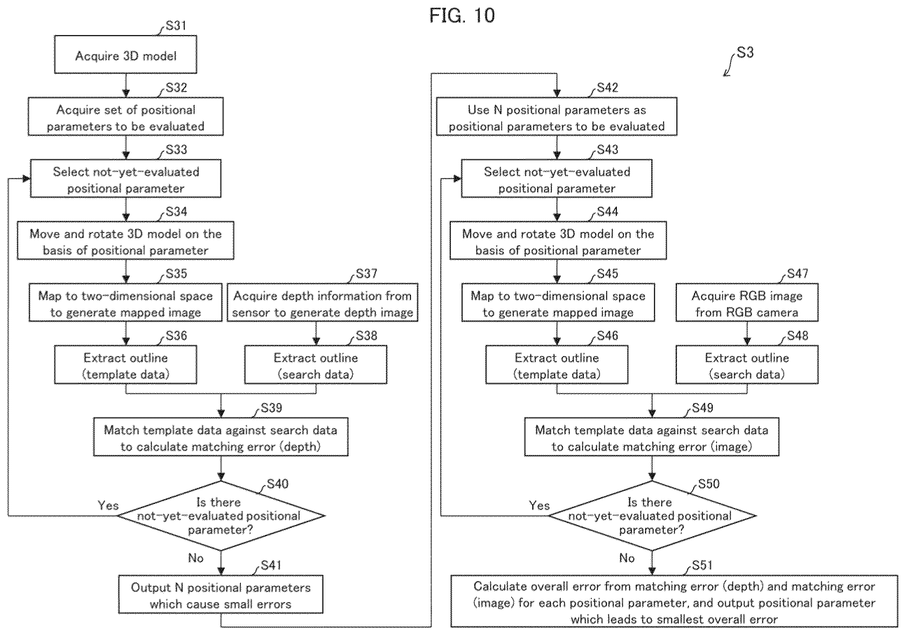

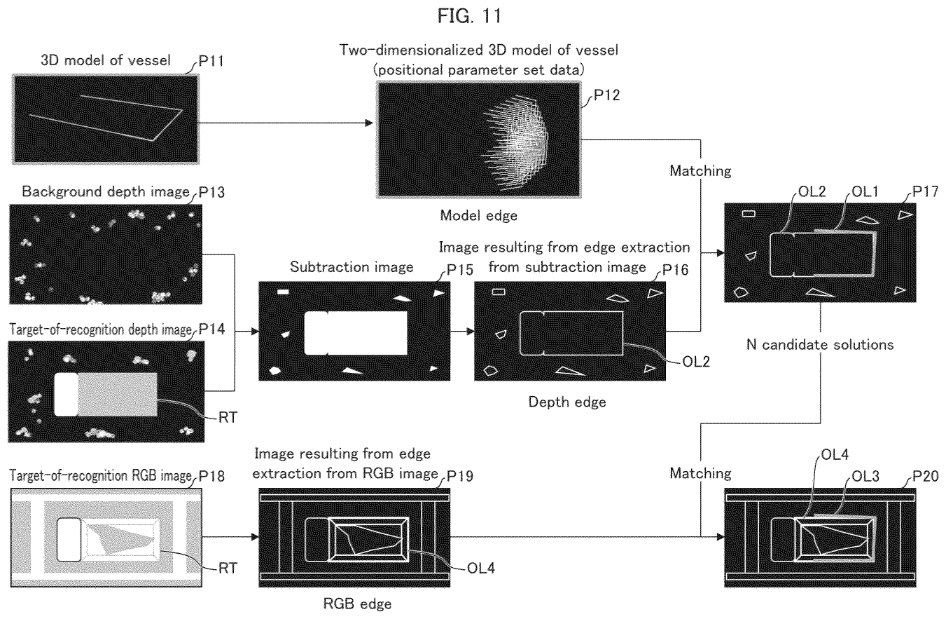

A flow of processes performed by the information processing apparatus 3 will be described below with use of FIGS. 10 and 11. FIG. 10 is a flowchart illustrating a flow of processes performed by the information processing apparatus 3 in accordance with the present example embodiment. FIG. 11 is a diagram illustrating an example of an image which is referred to or generated in each of the processes performed by the information processing apparatus 3 in accordance with the present example embodiment. The example illustrated in FIG. 11 will be described by taking the vessel of a dump truck as an example of the target object. A 3D model image P11 of the vessel in FIG. 11 is an image representing a 3D model of the vessel, which is the target object. As illustrated in FIG. 11, the 3D model of the vessel contains data on the edge of the vessel.

### (Step S31)

In the step S31, the information processing apparatus 3 acquires the 3D model 331. The information processing apparatus 3 stores, in the storing section 33, the 3D model 331 acquired.

### (Step S32)

In the step S32, the depth image position estimating section 313 acquires a set of positional parameters, to be evaluated, of the target object.

As described above, the positional parameters express potential positions and attitudes of the target object. In the example illustrated in FIG. 11, a set of potential positions and attitudes (set of potential positional parameters) of the vessel is applied to a 3D model image P11 of the vessel to two-dimensionalize the 3D model image P11. An image thus obtained is an image P12. The image P12 is also referred to as a “model edge”.

### (Step S33)

In the step S33, the depth image position estimating section 313 selects one not-yet-evaluated positional parameter from among the set of positional parameters indicating the positions and attitudes of the vessel. In the example illustrated in FIG. 11, the depth image position estimating section 313 selects a not-yet-evaluated positional parameter having been applied to the vessel from among a plurality of two-dimensionalized vessels contained in the image P12.

### (Step S34)

In the step S34, the depth image position estimating section 313 moves and rotates the 3D model 331 stored in the storing section 33, on the basis of the positional parameter selected.

### (Step S35)

In the step S35, the depth image position estimating section 313 maps, to a two-dimensional space, the 3D model 331 moved and rotated, to generate a mapped image. The mapped image generated by the depth image position estimating section 313 is characterized by being an image which represents the depth information regarding the 3D model 331.

### (Step S36)

In the step S36, the depth image position estimating section 313 extracts the outline (edge) of the target object in the mapped image. As an example, the depth image position estimating section 313 applies a first feature extracting process to the mapped image to extract the outline, which is a feature of the target object, and generates third two-dimensional data which indicates the outline. The third two-dimensional data generated by the depth image position estimating section 313 is also referred to as “template data”.

### (Step S37)

In the step S37, the depth information acquiring section 311 acquires the depth information obtained via the depth sensor 4 having a sensing range within which the target object lies. The depth information acquiring section 311 then supplies the depth image feature extracting section 312 with the depth information acquired.

The depth image feature extracting section 312 refers to the depth information supplied by the depth image feature extracting section 312, to generate a depth image. As an example, the depth image feature extracting section 312 acquires depth information obtained with the target object lying within the sensing range and depth information obtained with the target object not lying within the sensing range, to generate a depth image which contains the target object and a depth image for the case of the absence of the target object.

In the example illustrated in FIG. 11, the depth image feature extracting section 312 generates a target-of-recognition depth image P14 and a background depth image P13, the target-of-recognition depth image P14 being a depth image obtained with the target object RT lying within the sensing range, the background depth image P13 being a depth image for the case where the target object RT is not present within the sensing range.

### (Step S38)

In the step S38, the depth image feature extracting section 312 refers to the depth image to extract the outline of the target object. Data obtained by the depth image feature extracting section 312 extracting the outline of the target object is first two-dimensional data, and is also referred to as a “depth edge” or “search data”.

In the example illustrated in FIG. 11, the depth image feature extracting section 312 first calculates a difference between the target-of-recognition depth image P14 and the background depth image P13, to generate a subtraction image P15, which is subtraction information.

Next, the depth image feature extracting section 312 performs the first feature extracting process with reference to the subtraction information generated, to extract one or more features contained in the subtraction image. With this configuration, the information processing apparatus 3 performs, with reference to depth information having a reduced amount of information, the process of extracting a target object contained in the depth information and a feature of the target object. This makes it possible to reduce computational cost and computational time.

In the example illustrated in FIG. 11, the depth image feature extracting section 312 applies an edge extraction filter to the subtraction image P15, to generate an image P16 resulting from the extraction of an edge OL2 from the subtraction image. The image P16 is the first two-dimensional data (depth edge or search data). The depth image feature extracting section 312 supplies the depth image position estimating section 313 with the first two-dimensional data.

The depth image feature extracting section 312 may perform the first feature extracting process with reference to binarized subtraction information obtained by applying a binarizing process to the subtraction information. With this configuration, the information processing apparatus 3 refers to binarized subtraction information which is obtained by applying a binarizing process and which has a reduced amount of information. This makes it possible to reduce computational cost and computational time.

The processes of the step S37 and step S38 are examples of the processes performed by the depth image feature extracting section 312.

The step S37 and the step S38 may be performed in parallel with the steps S31 to S36, may be performed before the steps S31 to S36, or may be performed after the steps S31 to S36.

### (Step S39)

In the step S39, the depth image position estimating section 313 matches the template data (third two-dimensional data) extracted in the step S36 against the search data (first two-dimensional data) supplied by the depth image feature extracting section 312 in the step S38, to calculate a matching error. As an example, the depth image position estimating section 313 calculates a matching error by a template matching process in which the third two-dimensional data and the first two-dimensional data are referred to.

As an example of the template matching process, Chamfer Matching is cited, although the present example embodiment is not limited thereto. As another example, a method is cited whereby the depth image position estimating section 313 uses Perspective n Point (PnP), Interactive Closest Point (ICP), and Directional Chamfer Matching (DCM) to calculate a matching error, although the present example embodiment is not limited thereto.

In the example illustrated in FIG. 11, an image in which the image P16 and an outline OL1 are superimposed on top of each other is denoted as an image P17, the image P16 being the search data, the outline OL1 being the template data to be applied to the image P16. The depth image position estimating section 313 calculates an error between the edge OL2 contained in the image P16 and the outline OL1. This error is a matching error. The error calculated by the depth image position estimating section 313 is also referred to as a “matching error (depth)” for the purpose of indicating that this error is a matching error for the case of using depth information.

### (Step S40)

In the step S40, the depth image position estimating section 313 judges whether there is a not-yet-evaluated positional parameter.

In a case where the judgment in the step S40 is that there is a not-yet-evaluated positional parameter (step S40: YES), the depth image position estimating section 313 returns to the process of the step S33.

### (Step S41)

In a case where the judgment in the step S40 is that there is not a not-yet-evaluated positional parameter (step S40: NO), the depth image position estimating section 313 selects, in step S41, up to N positional parameters which lead to matching errors (depths) not greater than a predetermined threshold and thus cause small errors, and thereby provides N candidate solutions. In this respect, the depth image position estimating section 313 may select N positional parameters which cause relatively small errors, and thereby provide the N candidate solutions. With this configuration, the information processing apparatus 3 generates one or more candidate solutions by a template matching process in which the first two-dimensional data obtained with reference to depth information smaller in the amount of information than an RGB image is referred to. This makes it possible to reduce computational cost and computational time. The depth image position estimating section 313 supplies the RGB image position estimating section 316 with the N candidate solutions.

The above steps S32 to S36 and steps S39 to S41 are examples of the processes performed by the depth image position estimating section 313.

### (Step S42)

In the step S42, upon acquisition, from the depth image position estimating section 313, of the candidate solutions, which are N positional parameters, the RGB image position estimating section 316 uses the candidate solutions as positional parameters to be evaluated.

### (Step S43)

In the step S43, the RGB image position estimating section 316 selects one not-yet-evaluated positional parameter from among the N positional parameters.

### (Step S44)

In the step S44, the RGB image position estimating section 316 moves and rotates the 3D model 331 stored in the storing section 33, on the basis of the positional parameter selected.

### (Step S45)

In the step S45, the RGB image position estimating section 316 maps, to the two-dimensional space, the 3D model 331 moved and rotated, to generate a mapped image. The mapped image generated by the RGB image position estimating section 316 is characterized by being an image which contains texture information regarding the 3D model 331.

### (Step S46)

In the step S46, the RGB image position estimating section 316 extracts the outline of the target object in the mapped image. As an example, the RGB image position estimating section 316 applies a second feature extracting process to the mapped image to extract the outline (edge) of the target object, and generates fourth two-dimensional data which indicates the outline. The outline extracted by the RGB image position estimating section 316 may be a rectangular outline. The fourth two-dimensional data generated by the RGB image position estimating section 316 is also referred to as “template data”.

### (Step S47)

In the step S47, the RGB image acquiring section 314 acquires the RGB image obtained via the RGB camera 5 with the target object lying within an angle of view. The RGB image acquiring section 314 supplies the RGB image feature extracting section 315 with the RGB image acquired.

### (Step S48)

In the step S48, the RGB image feature extracting section 315 refers to the RGB image supplied by the RGB image acquiring section 314, to perform the second feature extracting process, and generates second two-dimensional data.

In the example illustrated in FIG. 11, the RGB image feature extracting section 315 extracts the rectangular outline of the target object contained in an RGB image P18. The rectangular outline is a feature of the target object. As an example of a method for extracting a rectangular shape, a known method may be used. The RGB image feature extracting section 315 generates an image P19 which contains an outline OL4 extracted, the image P19 is second two-dimensional data. The image P19 generated by the RGB image feature extracting section 315 is also referred to as an “RGB edge” or “search data”. The RGB image feature extracting section 315 supplies the RGB image position estimating section 316 with the second two-dimensional data generated.

The process of the step S48 is an example of the process performed by the RGB image feature extracting section 315.

The step S47 and the step S48 may be performed in parallel with the steps S42 to S46, may be performed before the steps S42 to S46, or may be performed after the steps S42 to S46.

### (Step S49)

In the step S49, the RGB image position estimating section 316 matches the template data (fourth two-dimensional data) extracted in the step S46 against the search data (second two-dimensional data) supplied by the RGB image feature extracting section 315 in the step S48, to calculate a matching error. As an example, the RGB image position estimating section 316 calculates a matching error by a template matching process in which the fourth two-dimensional data and the second two-dimensional data are referred to. As an example of the template matching process, Chamfer Matching is cited, although the present example embodiment is not limited thereto. As another example, a method is cited whereby the RGB image position estimating section 316 uses PnP, ICP, and DCM to calculate a matching error, although the present example embodiment is not limited thereto.

In the example illustrated in FIG. 11, an image in which the image P19 and an outline OL3 are superimposed on top of each other is denoted as an image P20, the image p19 being the search data, the outline OL3 being the template data to be applied to the image P19. The RGB image position estimating section 316 calculates an error between the outline OL4 contained in the image P19 and the outline OL3. This error is a matching error. The error calculated by the RGB image position estimating section 316 is also referred to as a “matching error (image)” for the purpose of indicating that this error is a matching error for the case of using an RGB image (image).

### (Step S50)

In the step S50, the RGB image position estimating section 316 judges whether there is a not-yet-evaluated positional parameter.

In a case where the judgment in the step S50 is that there is a not-yet-evaluated positional parameter (step S50: YES), the RGB image position estimating section 316 returns to the process of the step S43.

### (Step S51)

In the step S51, the RGB image position estimating section 316 calculates an overall error from the matching error (depth) and the matching error (image) calculated for each of the positional parameters, and selects a positional parameter which leads to the smallest overall error. In other words, the RGB image position estimating section 316 calculates at least one selected from the group consisting of the position and the attitude of the target object in the three-dimensional space. With this configuration, the information processing apparatus 3 performs a template matching process in which second two-dimensional data obtained with reference to an RGB image greater in the amount of information than depth information is referred to, to calculate at least one selected from the group consisting of the position and the attitude of a target object in the three-dimensional space. This makes it possible to suitably estimate at least one selected from the group consisting of the position and the attitude of the target object. The RGB image position estimating section 316 supplies the outputting section 32 with the parameter selected.

As an example, the RGB image position estimating section 316 can use the following mathematical formula (1) to calculate an overall error e, although the present example embodiment is not limited thereto.

e=wd*ed+wi*ei (1)

The variables in the mathematical formula (1) represent the following.
wd: weighting parameter
wi: weighting parameter
ed: matching error (depth)
ei: matching error (image)
   That is, the RGB image position estimating section 316 uses, as the overall error e, the sum of the following products: the product of the matching error (depth) ed and the weighting parameter wd; and the product of the matching error (image) ei and the weighting parameter wi, the matching error (depth) being calculated by the depth image position estimating section 313 in the step S39, the matching error (image) being calculated by the RGB image position estimating section 316 in the step S49.

As another example, the RGB image position estimating section 316 can use the following mathematical formula (2) to calculate the overall error e.

e=βd*exp(αd*ed)+βi*exp(αi*ei) (2)

The variables in the mathematical formula (2) represent the following.
βd: weighting parameter
βi: weighting parameter
αd: parameter
αi: parameter
ed: matching error (depth)
ei: matching error (image)
   That is, the RGB image position estimating section 316 first calculates the exponential of the product of the matching error (depth) ed and the parameter αd, the matching error (depth) being calculated by the depth image position estimating section 313 in the step S39. Subsequently, the RGB image position estimating section 316 calculates the product (value d) of the value calculated and the weighting parameter βd.

Next, the RGB image position estimating section 316 calculates the exponential of the product of the matching error (image) ei and the parameter αi, the matching error (image) being calculated by the RGB image position estimating section 316 in the step S49. Subsequently, the RGB image position estimating section 316 calculates the product (value i) of the value calculated and the weighting parameter βi.

The RGB image position estimating section 316 then uses, as the overall error e, the sum of the value d and the value i.

The RGB image position estimating section 316 may apply a data deleting process to the RGB image or the second two-dimensional data, the data deleting process being a process of deleting data which is at a predetermined distance or longer away from positions indicated by the N candidate solutions (in other words, data which indicates being at a predetermined distance or longer). In this case, the RGB image position estimating section 316 may refer to the captured image or the second two-dimensional data having been undergone the data deleting process, to calculate at least one selected from the group consisting of the position and the attitude of the target object in the three-dimensional space. With this configuration, the information processing apparatus 3 calculates at least one selected from the group consisting of the position and the attitude of a target object in the three-dimensional space without processing data other than data on the target object. This makes it possible to reduce computational cost and computational time.

The above steps S49 to S51 are examples of the processes performed by the RGB image position estimating section 316.

Further, in the flowchart illustrated in FIG. 10, the information processing apparatus 3 may have the following configuration: the order in which to perform the steps S37 to S39 and the steps S47 to S49 are exchanged, and furthermore, the processes of the steps S32 to S36 and the steps S39 to S41 are performed by the RGB image position estimating section 316 instead of the depth image position estimating section 313, and the processes of the steps S42 to S46 and the steps S49 to S51 are performed by the depth image position estimating section 313 instead of the RGB image position estimating section 316.

In other words, in the step S47, the RGB image acquiring section 314 acquires a captured image obtained via the RGB camera 5 having an angle of view within which a target object lies, and in the step S39, the RGB image position estimating section 316 refers to: second two-dimensional data obtained through a second feature extracting process in which the captured image is referred to; and a three-dimensional model, to generate one or more candidate solutions regarding at least one selected from the group consisting of the position and the attitude of the target object in a three-dimensional space.

Next, in the step S37, the depth information acquiring section 311 acquires depth information obtained via the depth sensor 4 having a sensing range within which the target object lies, and in the step S49, the depth image position estimating section 313 refers to: first two-dimensional data obtained through a first feature extracting process in which the depth information is referred to; and the three-dimensional model and uses the one or more candidate solutions, to calculate at least one selected from the group consisting of the position and the attitude of the target object in the three-dimensional space.

Also with this configuration, the information processing apparatus 3 provides an example advantage approximately the same as that of the information processing apparatus 1.

As above, in the information processing system 100 in accordance with the present example embodiment, the information processing apparatus 3 includes a depth information acquiring section 311, an RGB image acquiring section 314, a depth image position estimating section 313, and an RGB image position estimating section 316, the depth information acquiring section 311 acquiring depth information obtained via the depth sensor 4 having a sensing range within which a target object lies, the RGB image acquiring section 314 acquiring an RGB image obtained via an RGB camera 5 having an angle of view within which the target object lies, the depth image position estimating section 313 generating, with reference to first two-dimensional data and a 3D model 331 regarding the target object, one or more candidate solutions regarding at least one selected from the group consisting of the position and the attitude of the target object in a three-dimensional space, the first two-dimensional data being obtained through a first feature extracting process in which the depth information is referred to, the RGB image position estimating section 316 calculating, with reference to second two-dimensional data and the 3D model 331 and with use of the one or more candidate solutions, at least one selected from the group consisting of the position and the attitude of the target object in the three-dimensional space, the second two-dimensional data being obtained through a second feature extracting process in which the RGB image is referred to.

Thus, with the information processing system 100 in accordance with the present example embodiment, the information processing apparatus 3 provides the same example advantage as the information processing apparatus 1.

### Fourth Example Embodiment

The following description will discuss a fourth example embodiment of the present invention in detail, with reference to the drawings. A component which has the same function as the component described in the above example embodiments is assigned the same reference, and the description thereof is not repeated.

### (Configuration of Information Processing System 100A)

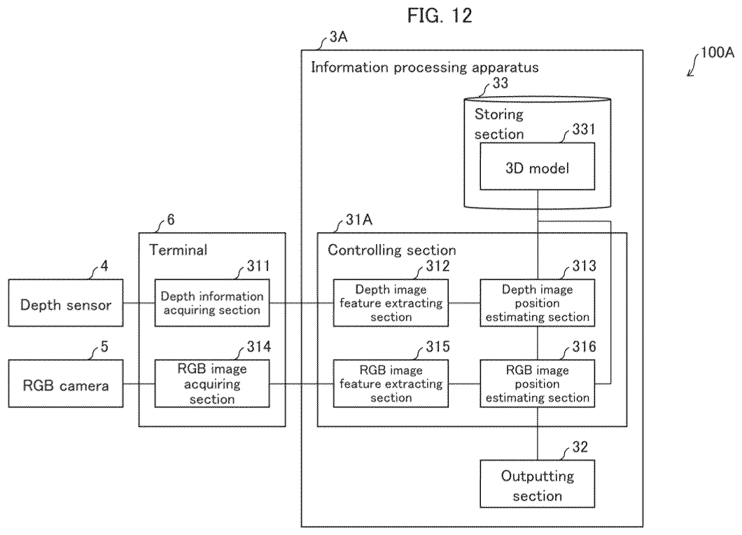

A configuration of an information processing system 100A in accordance with the present example embodiment will be described below with reference to FIG. 12. FIG. 12 is a block diagram illustrating a configuration of the information processing system 100A in accordance with the present example embodiment.

The information processing system 100A includes an information processing apparatus 3A, a depth sensor 4, an RGB camera 5, and a terminal 6, as illustrated in FIG. 12. The depth sensor 4 and the RGB camera 5 are as described in the above example embodiments.

In the information processing system 100A, the terminal 6 acquires depth information obtained via the depth sensor 4 with a target object lying within the sensing range, and acquires captured image information obtained via the RGB camera 5 with the target object lying within the angle of view. Further, in the information processing system 100A, the information processing apparatus 3A calculates, with reference to the depth information and the captured image information acquired by the terminal 6, at least one selected from the group consisting of the position and the attitude of the target object in a three-dimensional space. The target object, the depth information, and the position and the attitude of the target object are as described in the above example embodiments.

### (Configuration of Terminal 6)

The terminal 6 includes a depth information acquiring section 311 and an RGB image acquiring section 314, as illustrated in FIG. 12.

The depth information acquiring section 311 acquires depth information obtained via the depth sensor 4 having a sensing range within which a target object lies. Further, the depth information acquiring section 311 acquires depth information in the sensing range, the depth information being obtained via the depth sensor 4, even in a case where the target object is not present within the sensing range. The depth information acquiring section 311 outputs, to the information processing apparatus 3A, the depth information acquired.

The RGB image acquiring section 314 acquires an RGB image (captured image) obtained via the RGB camera 5 having an angle of view within which the target object lies. The RGB image acquiring section 314 outputs, to the information processing apparatus 3A, the RGB image acquired.

### (Configuration of Information Processing Apparatus 3A)

The information processing apparatus 3A includes a controlling section 31A, an outputting section 32, and a storing section 33, as illustrated in FIG. 12. The outputting section 32 and the storing section 33 are as described in the above example embodiments.

The controlling section 31A controls the components of the information processing apparatus 3A. The controlling section 31A also functions as a depth image feature extracting section 312, a depth image position estimating section 313, an RGB image feature extracting section 315, and an RGB image position estimating section 316, as illustrated in FIG. 12. The depth image position estimating section 313 and the RGB image position estimating section 316 are as described in the above example embodiments.

The depth image feature extracting section 312 performs a first feature extracting process in which the depth information outputted by the terminal 6 is referred to, to generate first two-dimensional data. The depth image feature extracting section 312 supplies the depth image position estimating section 313 with the first two-dimensional data generated. An example of the process performed by the depth image feature extracting section 312 is as described in the above example embodiments.

The RGB image feature extracting section 315 performs a second feature extracting process in which the RGB image outputted by the terminal 6 is referred to, to generate second two-dimensional data. The RGB image feature extracting section 315 supplies the RGB image position estimating section 316 with the second two-dimensional data generated. An example of the process performed by the RGB image feature extracting section 315 is as described in the above example embodiments.

As above, in the information processing system 100A in accordance with the present example embodiment, the terminal 6 acquires depth information and an RGB image, and outputs, to the information processing apparatus 3A, the depth information and the RGB image acquired. The information processing apparatus 3A refers to the depth information and the RGB image outputted by the terminal 6, to calculate at least one selected from the group consisting of the position and the attitude of the target object in a three-dimensional space. Thus, in the information processing system 100A in accordance with the present example embodiment, the information processing apparatus 3A, which does not need to acquire depth information or an RGB image directly from the depth sensor 4 and the RGB camera 5, can be implemented with use of a server or the like disposed at a physical distance from the depth sensor 4 and the RGB camera 5.

### Fifth Example Embodiment

The following description will discuss a fifth example embodiment of the present invention in detail, with reference to the drawings. A component which has the same function as the component described in the above example embodiments is assigned the same reference, and the description thereof is not repeated.

### (Configuration of Information Processing System 100B)

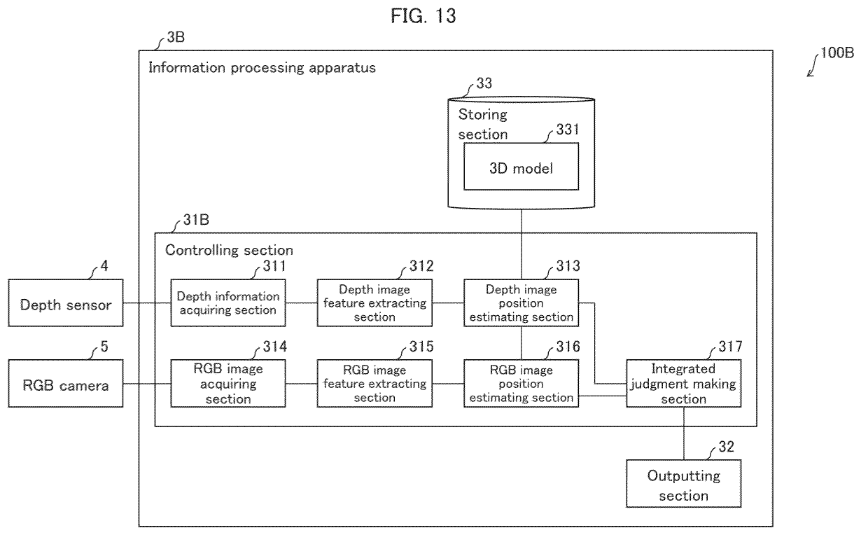

A configuration of an information processing system 100B in accordance with the present example embodiment will be described below with reference to FIG. 13. FIG. 13 is a block diagram illustrating a configuration of the information processing system 100B in accordance with the present example embodiment.

The information processing system 100B includes an information processing apparatus 3B, a depth sensor 4, and an RGB camera 5, as illustrated in FIG. 13. The depth sensor 4 and the RGB camera 5 are as described in the above example embodiments.

In the information processing system 100B, like the information processing apparatus 3, the information processing apparatus 3B acquires depth information obtained via the depth sensor 4 with a target object lying within the sensing range, and acquires captured image information obtained via the RGB camera 5 with the target object lying within the angle of view. The information processing apparatus 3B then calculates, with reference to the depth information and the captured image information acquired, at least one selected from the group consisting of the position and the attitude of the target object. The target object, the depth information, and the position and the attitude of the target object are as described in the above example embodiments.

### (Configuration of Information Processing Apparatus 3B)

The information processing apparatus 3B includes a controlling section 31B, an outputting section 32, and a storing section 33, as illustrated in FIG. 13. The outputting section 32 and the storing section 33 are as described in the above example embodiments.

The controlling section 31B controls the components of the information processing apparatus 3B. The controlling section 31B also functions as a depth information acquiring section 311, a depth image feature extracting section 312, a depth image position estimating section 313, an RGB image acquiring section 314, an RGB image feature extracting section 315, an RGB image position estimating section 316, and an integrated judgment making section 317, as illustrated in FIG. 13. The depth information acquiring section 311, the depth image feature extracting section 312, the RGB image acquiring section 314, and the RGB image feature extracting section 315 are as described in the above example embodiments.

The depth information acquiring section 311, the depth image position estimating section 313, the RGB image acquiring section 314, the RGB image position estimating section 316, and the integrated judgment making section 317 implement the depth information acquiring means, the first matching means, the captured image acquiring means, the second matching means, and the calculating means, respectively, in the present example embodiment.

The depth image position estimating section 313 performs a first matching process in which first two-dimensional data and a 3D model 331 are referred to, the first two-dimensional data being supplied by the depth image feature extracting section 312, the 3D model 331 being stored in the storing section 33. The first two-dimensional data and the first matching process are as described in the above example embodiments. The depth image position estimating section 313 supplies the integrated judgment making section 317 with a result of the first matching process.

In addition, the depth image position estimating section 313 supplies the RGB image position estimating section 316 with an image resulting from movement or rotation of the 3D model 331 stored in the storing section 33.

The RGB image position estimating section 316 performs a second matching process in which second two-dimensional data and the 3D model 331 are referred to, the second two-dimensional data being supplied by the RGB image feature extracting section 315, the 3D model 331 being stored in the storing section 33. The second two-dimensional data and the second matching process are as described in the above example embodiments. The RGB image position estimating section 316 supplies the integrated judgment making section 317 with a result of the second matching process.

The integrated judgment making section 317 refers to the result of the first matching process supplied by the depth image position estimating section 313 and the result of the second matching process supplied by the RGB image position estimating section 316, to calculate at least one selected from the group consisting of the position and the attitude of the target object in the three-dimensional space. An example of a method whereby the integrated judgment making section 317 calculates at least one selected from the group consisting of the position and the attitude of the target object in the three-dimensional space is the same as the above example of a method whereby the RGB image position estimating section 316 calculates at least one selected from the group consisting of the position and the attitude of the target object in the three-dimensional space, and the description thereof is therefore omitted.

### (Flow of Processes Performed by Information Processing Apparatus 3B)

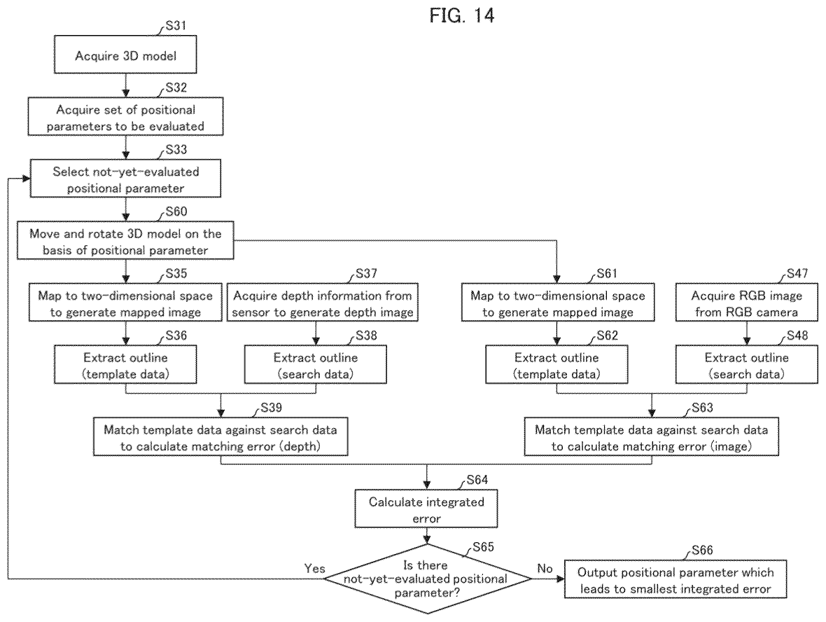

A flow of the processes performed by the information processing apparatus 3B will be described below with use of FIG. 14. FIG. 14 is a flowchart illustrating a flow of processes performed by the information processing apparatus 3B in accordance with the present example embodiment.

### (Step S31)

In the step S31, the information processing apparatus 3B acquires the 3D model 331. The information processing apparatus 3B stores, in the storing section 33, the 3D model 331 acquired.

### (Step S32)

In the step S32, the depth image position estimating section 313 acquires a set of positional parameters, to be evaluated, of the target object. The positional parameters are as described above.

### (Step S33)

In the step S33, the depth image position estimating section 313 selects one not-yet-evaluated positional parameter from among the set of positional parameters indicating the positions and attitudes of the vessel.

### (Step S60)

In the step S60, the depth image position estimating section 313, the depth image position estimating section 313 moves and rotates the 3D model 331 stored in the storing section 33, on the basis of the positional parameter selected. The depth image position estimating section 313 supplies the RGB image position estimating section 316 with the 3D model 331 moved and rotated.

### (Step S35)

In the step S35, the depth image position estimating section 313 maps, to a two-dimensional space, the 3D model 331 moved and rotated, to generate a mapped image.

### (Step S36)

In the step S36, the depth image position estimating section 313 extracts the outline (edge) of the target object in the mapped image. As an example, the depth image position estimating section 313 applies a first feature extracting process to the mapped image to extract the outline, which is a feature of the target object, and generates third two-dimensional data which indicates the outline. The third two-dimensional data generated by the depth image position estimating section 313 is also referred to as “template data”.

### (Step S37)

In the step S37, the depth information acquiring section 311 acquires the depth information obtained via the depth sensor 4 having a sensing range within which the target object lies. The depth information acquiring section 311 then supplies the depth image feature extracting section 312 with the depth information acquired.

The depth image feature extracting section 312 refers to the depth information supplied by the depth image feature extracting section 312, to generate a depth image. As an example, the depth image feature extracting section 312 acquires depth information obtained with the target object lying within the sensing range and depth information obtained with the target object not lying within the sensing range, to generate a depth image which contains the target object and a depth image for the case of the absence of the target object.

### (Step S38)

In the step S38, the depth image feature extracting section 312 refers to the depth image to extract the outline of the target object. Data obtained by the depth image feature extracting section 312 extracting the outline of the target object is first two-dimensional data, and is also referred to as a “depth edge” or “search data”.

As an example, as in the above example embodiments, the depth image feature extracting section 312 first refers to the depth information obtained with the target object lying within the sensing range and the depth information obtained with the target object not lying within the sensing range, to generate a subtraction image, is subtraction information. An example of the subtraction image is as illustrated as the above-described subtraction image P15 in FIG. 11.

Next, the depth image feature extracting section 312, the depth image feature extracting section 312 performs the first feature extracting process with reference to the subtraction information generated, to extract one or more features (such as an outline and an edge) contained in the subtraction image. An example of the image resulting from extraction, by the depth image feature extracting section 312, of the one or more features is as illustrated as the above-described image P16 in FIG. 11.

As in the above example embodiments, the depth image feature extracting section 312 may perform the first feature extracting process with reference to binarized subtraction information obtained by applying a binarizing process to the subtraction information. With this configuration, the information processing apparatus 3B refers to binarized subtraction information obtained by applying a binarizing process and having a reduced amount of information. This makes it possible to reduce computational cost and computational time.

The steps S37 and S38 may be performed in parallel with the steps S31 to S33, S60, S35, and S36, may be performed before the steps S31 to S33, S60, S35, and S36, or may be performed after the steps S31 to S33, S60, S35, and S36.

### (Step S39)

In the step S39, the depth image position estimating section 313 performs the first matching process of matching the template data (third two-dimensional data) extracted in the step S36 against the search data (first two-dimensional data) supplied by the depth image feature extracting section 312 in the step S38, to calculate a matching error (depth). As an example, the depth image position estimating section 313 calculates a matching error (depth) by a template matching process in which the third two-dimensional data and the first two-dimensional data are referred to. The depth image position estimating section 313 supplies the integrated judgment making section 317 with the matching error (depth) calculated.

As in the above example embodiments, Chamfer Matching is cited as an example of the template matching process, and a method in which PnP, ICP, and DCM are used is cited as an example of the calculation of the matching error, although the present example embodiment is not limited thereto.

In the step S39, an example of the first matching process performed by the depth image position estimating section 313 is as described with use of the above image P17 in FIG. 11.

### (Step S61)

In the step S61, the RGB image position estimating section 316 maps, to the two-dimensional space, the 3D model 331 supplied by the depth image position estimating section 313, the 3D model 331 having been moved and rotated, to generate a mapped image.

### (Step S62)

In the step S62, the RGB image position estimating section 316 extracts the outline of the target object in the mapped image. As an example, the RGB image position estimating section 316 applies a second feature extracting process to the mapped image to extract the outline (edge) of the target object, and generates fourth two-dimensional data which indicates the outline. The fourth two-dimensional data generated by the RGB image position estimating section 316 is also referred to as “template data”.

### (Step S47)

In the step S47, the RGB image acquiring section 314 acquires the RGB image obtained via the RGB camera 5 with the target object lying within an angle of view. The RGB image acquiring section 314 supplies the RGB image feature extracting section 315 with the RGB image acquired.

### (Step S48)

In the step S48, the RGB image feature extracting section 315 refers to the RGB image supplied by the RGB image acquiring section 314, to perform the second feature extracting process, and generates second two-dimensional data. The second two-dimensional data generated by the RGB image feature extracting section 315 is also referred to as an “RGB edge” or “search data”. An example of the second two-dimensional data is as illustrated as the above-described image P19 in FIG. 11.

The steps S47 and S48 may be performed in parallel with the steps S61 and S62, may be performed before the steps S61 and S62, or may be performed after the steps S61 and S62.

### (Step S63)

In the step S63, the RGB image position estimating section 316 performs the second matching process of matching the template data (fourth two-dimensional data) extracted in the step S62 against the search data (second two-dimensional data) supplied by the RGB image feature extracting section 315 in the step S48, to calculate a matching error (image). As an example, the RGB image position estimating section 316 calculates a matching error by a template matching process in which the fourth two-dimensional data and the second two-dimensional data are referred to. The RGB image position estimating section 316 supplies the integrated judgment making section 317 with the matching error (image) calculated.

As in the above example embodiments, Chamfer Matching is cited as an example of the template matching process, and a method in which PnP, ICP, and DCM are used is cited as an example of the calculation of the matching error, although the present example embodiment is not limited thereto.

An example of the second matching process performed by the RGB image position estimating section 316 in the step S63 is as described with use of the above image P20 in FIG. 11.

The step S63 may be performed in parallel with the step S39, may be performed before the step S39, or may be performed after the step S39.

### (Step S64)

In the step S64, the integrated judgment making section 317 refers to the matching error (depth) supplied by the depth image position estimating section 313 in the step S39 and the matching error (image) supplied by the RGB image position estimating section 316 in the step S63, to calculate an integrated error.

As in the case of the method whereby the RGB image position estimating section 316 calculates the overall error in the above example embodiments, as an example of a method whereby the integrated judgment making section 317 calculates the integrated error, a method of calculating an integrated error e with use of the following mathematical formula (3) is cited, although the present example embodiment is not limited thereto.

e=wd*ed+wi*ei (3)

The variables in the mathematical formula (3) represent the following.
wd: weighting parameter
wi: weighting parameter
ed: matching error (depth)
ei: matching error (image)
   That is, the integrated judgment making section 317 uses, as the overall error e, the sum of the following products: the product of the matching error (depth) ed and the weighting parameter wd; and the product of the matching error (image) ei and the weighting parameter wi, the matching error (depth) being calculated by the depth image position estimating section 313 in the step S39, the matching error (image) being calculated by the RGB image position estimating section 316 in the step S63.

As another example, the integrated judgment making section 317 can use the following mathematical formula (4) to calculate the integrated error e.

e=βd*exp(αd*ed)+βi*exp(αi*ei) (4)

The variables in the mathematical formula (4) represent the following.
βd: weighting parameter
βi: weighting parameter
αd: parameter
αi: parameter
ed: matching error (depth)
ei: matching error (image)
   That is, the integrated judgment making section 317 first calculates the exponential of the product of the matching error (depth) ed and the parameter αd, the matching error (depth) being calculated by the depth image position estimating section 313 in the step S39. Subsequently, the integrated judgment making section 317 calculates the product (value d) of the value calculated and the weighting parameter βd.

Next, the integrated judgment making section 317 calculates the exponential of the product of the matching error (image) ei and the parameter αi, the matching error (image) being calculated by the RGB image position estimating section 316 in the step S63. Subsequently, the integrated judgment making section 317 calculates the product (value i) of the value calculated and the weighting parameter βi.

The integrated judgment making section 317 then uses, as the overall error e, the sum of the value d and the value i.

### (Step S65)

In the step S65, the integrated judgment making section 317 judges whether there is a not-yet-evaluated positional parameter.

In a case where the judgment in the step S65 is that there is a not-yet-evaluated positional parameter (step S65: YES), the information processing apparatus 3B returns to the process of the step S33.

### (Step S66)

In a case where the judgment in the step S65 is that there is not a not-yet-evaluated positional parameter (step S65: NO), the integrated judgment making section 317 selects a positional parameter which leads to the smallest integrated error. In other words, the integrated judgment making section 317 calculates at least one selected from the group consisting of the position and the attitude of the target object in the three-dimensional space. The integrated judgment making section 317 outputs, to the outputting section 32, the positional parameter selected.

As above, in the information processing system 100B in accordance with the present example embodiment, the information processing apparatus 3B includes a depth information acquiring section 311, an RGB image acquiring section 314, a depth image position estimating section 313, an RGB image position estimating section 316, and an integrated judgment making section 317, the depth information acquiring section 311 acquiring depth information obtained via a depth sensor 4 having a sensing range within which a target object lies, the RGB image acquiring section 314 acquiring a captured image obtained via an RGB camera 5 having an angle of view within which the target object lies, the depth image position estimating section 313 performing a first feature extracting process in which first two-dimensional data and a 3D model 331 regarding the target object are referred to, the first two-dimensional data being obtained through a first feature extracting process in which the depth information is referred to, the RGB image position estimating section 316 performing a second matching process in which second two-dimensional data and the 3D model 331 are referred to, the second two-dimensional data being obtained through a second feature extracting process in which the captured image is referred to, the integrated judgment making section 317 calculating, with reference to a result of the first matching process and a result of the second matching process, at least one selected from the group consisting of the position and the attitude of the target object in a three-dimensional space.

Thus, in the information processing system 100B in accordance with the present example embodiment, the information processing apparatus 3B needs to perform the process of moving and rotating the 3D model 331 only once for one positional parameter. This makes it possible to reduce computational cost and computational time.

Optionally, in the information processing system 100B in accordance with the present example embodiment, the information processing apparatus 3B does not perform the second matching process in a case where the matching error is large in the first matching process, which is performed at high speed because of a small amount of information. Thus, in the information processing system 100B in accordance with the present example embodiment, it is possible for the information processing apparatus 3B to reduce computational cost and computational time.

### Sixth Example Embodiment

The following description will discuss a sixth example embodiment of the present invention in detail, with reference to the drawings. A component which has the same function as the component described in the above example embodiments is assigned the same reference, and the description thereof is not repeated.

### (Configuration of Information Processing System 100C)

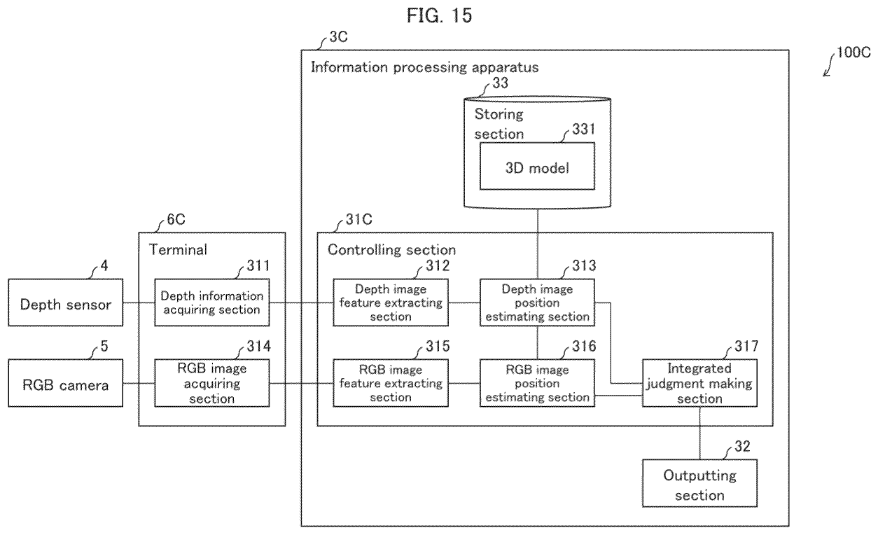

A configuration of an information processing system 100C in accordance with the present example embodiment will be described below with reference to FIG. 15. FIG. 15 is a block diagram illustrating a configuration of the information processing system 100C in accordance with the present example embodiment.

The information processing system 100C includes an information processing apparatus 3C, a depth sensor 4, an RGB camera 5, and a terminal 6C, as illustrated in FIG. 15. The depth sensor 4 and the RGB camera 5 are as described in the above example embodiments.

In the information processing system 100C, the terminal 6C acquires depth information obtained via the depth sensor 4 with a target object lying within the sensing range, and acquires captured image information obtained via the RGB camera 5 with the target object lying within the angle of view. Further, in the information processing system 100C, the information processing apparatus 3C calculates, with reference to the depth information and the captured image information acquired by the terminal 6C, at least one selected from the group consisting of the position and the attitude of the target object in a three-dimensional space.

The target object, the depth information, and the position and the attitude of the target object are as described in the above example embodiments.

### (Configuration of Terminal 6C)

The terminal 6C includes a depth information acquiring section 311 and an RGB image acquiring section 314, as illustrated in FIG. 15.

The depth information acquiring section 311 acquires depth information obtained via the depth sensor 4 having a sensing range within which a target object lies. Further, the depth information acquiring section 311 acquires depth information in the sensing range, the depth information being obtained via the depth sensor 4, even in a case where the target object is not present within the sensing range. The depth information acquiring section 311 outputs, to the information processing apparatus 3C, the depth information acquired.

The RGB image acquiring section 314 acquires an RGB image (captured image) obtained via the RGB camera 5 having an angle of view within which the target object lies. The RGB image acquiring section 314 outputs, to the information processing apparatus 3C, the RGB image acquired.

### (Configuration of Information Processing Apparatus 3C)

The information processing apparatus 3C includes a controlling section 31C, an outputting section 32, and a storing section 33, as illustrated in FIG. 15. The outputting section 32 and the storing section 33 are as described in the above example embodiments.

The controlling section 31C controls the components of the information processing apparatus 3C. The controlling section 31C also functions as a depth image feature extracting section 312, a depth image position estimating section 313, an RGB image feature extracting section 315, an RGB image position estimating section 316, and an integrated judgment making section 317, as illustrated in FIG. 15. The depth image position estimating section 313, the RGB image position estimating section 316, and the integrated judgment making section 317 are as described in the above example embodiments.

The depth image feature extracting section 312 performs a first feature extracting process in which the depth information outputted by the terminal 6C is referred to, to generate first two-dimensional data. The depth image feature extracting section 312 supplies the depth image position estimating section 313 with the first two-dimensional data generated. An example of the process performed by the depth image feature extracting section 312 is as described in the above example embodiments.

The RGB image feature extracting section 315 performs a second feature extracting process in which the RGB image outputted by the terminal 6C is referred to, to generate second two-dimensional data. The RGB image feature extracting section 315 supplies the RGB image position estimating section 316 with the second two-dimensional data generated. An example of the process performed by the RGB image feature extracting section 315 is as described in the above example embodiments.

As above, in the information processing system 100C in accordance with the present example embodiment, the terminal 6C acquires depth information and an RGB image, and outputs, to the information processing apparatus 3C, the depth information and the RGB image acquired. The information processing apparatus 3C refers to the depth information and the RGB image outputted by the terminal 6C, to calculate at least one selected from the group consisting of the position and the attitude of the target object in a three-dimensional space. Thus, in the information processing system 100C in accordance with the present example embodiment, the information processing apparatus 3C, which does not need to acquire depth information or an RGB image directly from the depth sensor 4 and the RGB camera 5, can be implemented with use of a server disposed at a physical distance from the depth sensor 4 and the RGB camera 5.

### [Software Implementation Example]

Some or all of the functions of the information processing apparatuses 1, 2, 3, 3A, 3B, and 3C, and the information processing systems 10, 20, 100, 100A, 100B, and 100C may be implemented by hardware such as an integrated circuit (IC chip), or may be implemented by software.

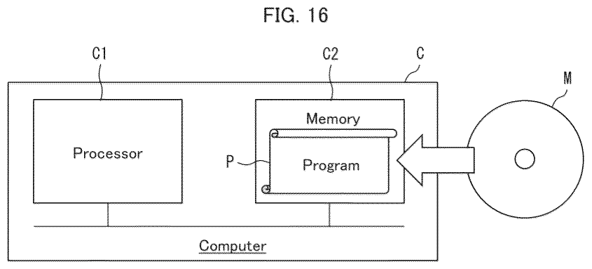

In the latter case, the information processing apparatuses 1, 2, 3, 3A, 3B, and 3C and the information processing systems 10, 20, 100, 100A, 100B, and 100C are provided by, for example, a computer that executes instructions of a program that is software implementing the foregoing functions. An example (hereinafter, computer C) of such a computer is illustrated in FIG. 16. The computer C includes at least one processor C1 and at least one memory C2. The memory C2 has stored therein a program P for causing the computer C to operate as the information processing apparatuses 1, 2, 3, 3A, 3B, and 3C and the information processing systems 10, 20, 100, 100A, 100B, and 100C. The processor C1 of the computer C retrieves the program P from the memory C2 and executes the program P, so that the functions of the information processing apparatuses 1, 2, 3, 3A, 3B, and 3C and the information processing systems 10, 20, 100, 100A, 100B, and 100C are implemented.

Examples of the processor C1 can include a central processing unit (CPU), a graphic processing unit (GPU), a digital signal processor (DSP), a micro processing unit (MPU), a floating point number processing unit (FPU), a physics processing unit (PPU), a microcontroller, and a combination thereof. Examples of the memory C2 can include a flash memory, a hard disk drive (HDD), a solid state drive (SSD), and a combination thereof.

The computer C may further include a random access memory (RAM) into which the program Pis loaded at the time of execution and in which various kinds of data are temporarily stored. The computer C may further include a communication interface via which data is transmitted to and received from another apparatus. The computer C may further include an input-output interface via which input-output equipment such as a keyboard, a mouse, a display or a printer is connected.

The program P can be recorded on a non-transitory, tangible recording medium M capable of being read by the computer C. Examples of such a recording medium M can include a tape, a disk, a card, a semiconductor memory, and a programmable logic circuit. The computer C can obtain the program P via such a recording medium M. Alternatively, the program P can be transmitted through a transmission medium. Examples of such a transmission medium can include a communication network and a broadcast wave. The computer C can obtain the program P also via such a transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the above example embodiments.

### [Additional Remark 2]

The whole or part of the example embodiments disclosed above can be described as, but not limited to, the following supplementary notes.

### (Supplementary Note 1)

An information processing apparatus including: a depth information acquiring means for acquiring depth information obtained via a depth sensor having a sensing range within which a target object lies; a captured image acquiring means for acquiring a captured image obtained via an imaging sensor having an angle of view within which the target object lies; a generating means for generating, with reference to first two-dimensional data and third two-dimensional data, one or more candidate solutions regarding at least one selected from the group consisting of a position and an attitude of the target object in a three-dimensional space, the first two-dimensional data being obtained through a first feature extracting process in which the depth information is referred to, the third two-dimensional data being obtained through a first feature extracting process in which an image resulting from mapping of a three-dimensional model regarding the target object to a two-dimensional space is referred to; and a calculating means for calculating, with reference to second two-dimensional data and fourth two-dimensional data and with use of the one or more candidate solutions, at least one selected from the group consisting of the position and the attitude of the target object in the three-dimensional space, the second two-dimensional data being obtained through a second feature extracting process in which the captured image is referred to, the fourth two-dimensional data being obtained through a second feature extracting process in which an image resulting from mapping of the three-dimensional model regarding the target object to the two-dimensional space is referred to.

### (Supplementary Note 2)

The information processing apparatus described in supplementary note 1, in which the first feature extracting process and the second feature extracting process include an edge extracting process, and the three-dimensional model contains data on an edge of the target object.

### (Supplementary Note 3)

The information processing apparatus described in supplementary note 1 or 2, in which the depth information acquiring means is configured to acquire depth information in the sensing range even in a case where the target object is not present within the sensing range, and the first feature extracting process is a feature extracting process in which subtraction information is referred to, the subtraction information being a difference between the depth information for the target object lying within the sensing range and the depth information for the target object not present within the sensing range.

### (Supplementary Note 4)

The information processing apparatus described in supplementary note 3, in which the first feature extracting process is a feature extracting process in which binarized subtraction information is referred to, the binarized subtraction information being obtained by applying a binarizing process to the subtraction information.

### (Supplementary Note 5)

The information processing apparatus described in any one of supplementary notes 1 to 4, in which the calculating means is configured to apply, to the captured image or the second two-dimensional data, a data deleting process of deleting data which indicates being at a predetermined distance or longer away from positions indicated by the one or more candidate solutions, and calculate at least one selected from the group consisting of the position and the attitude of the target object in the three-dimensional space, with reference to the captured image or the second two-dimensional data having undergone the data deleting process.

### (Supplementary Note 6)

The information processing apparatus described in any one of supplementary notes 1 to 5, in which the generating means is configured to generate the one or more candidate solutions through a template matching process in which the third two-dimensional data and the first two-dimensional data are referred to.

### (Supplementary Note 7)

The information processing apparatus described in any one of supplementary notes 1 to 6, in which the calculating means is configured to calculate at least one selected from the group consisting of the position and the attitude of the target object in the three-dimensional space through a template matching process in which the fourth two-dimensional data and the second two-dimensional data are referred to.

### (Supplementary Note 8)

An information processing apparatus including: a depth information acquiring means for acquiring depth information obtained via a depth sensor having a sensing range within which a target object lies; a captured image acquiring means for acquiring a captured image obtained via an imaging sensor having an angle of view within which the target object lies; a first matching means for performing a first matching process in which first two-dimensional data and third two-dimensional data are referred to, the first two-dimensional data being obtained through a first feature extracting process in which the depth information is referred to, the third two-dimensional data being obtained through a first feature extracting process in which an image resulting from mapping of a three-dimensional model regarding the target object to a two-dimensional space is referred to; a second matching means for performing a second matching process in which second two-dimensional data and fourth two-dimensional data are referred to, the second two-dimensional data being obtained through a second feature extracting process in which the captured image is referred to, the fourth two-dimensional data being obtained through a second feature extracting process in which an image resulting from mapping of the three-dimensional model regarding the target object to the two-dimensional space is referred to; and a calculating means for calculating at least one selected from the group consisting of a position and an attitude of the target object in the three-dimensional space, with reference to a result of the first matching process and a result of the second matching process.

### (Supplementary Note 9)

An information processing method including: acquiring depth information obtained via a depth sensor having a sensing range within which a target object lies; acquiring a captured image obtained via an imaging sensor having an angle of view within which the target object lies; generating, with reference to first two-dimensional data and third two-dimensional data, one or more candidate solutions regarding at least one selected from the group consisting of a position and an attitude of the target object in a three-dimensional space, the first two-dimensional data being obtained through a first feature extracting process in which the depth information is referred to, the third two-dimensional data being obtained through a first feature extracting process in which an image resulting from mapping of a three-dimensional model regarding the target object to a two-dimensional space is referred to; and calculating, with reference to second two-dimensional data and fourth two-dimensional data and with use of the one or more candidate solutions, at least one selected from the group consisting of the position and the attitude of the target object in the three-dimensional space, the second two-dimensional data being obtained through a second feature extracting process in which the captured image is referred to, the fourth two-dimensional data being obtained through a second feature extracting process in which an image resulting from mapping of the three-dimensional model regarding the target object to the two-dimensional space is referred to.

### (Supplementary Note 10)

An information processing method including: acquiring depth information obtained via a depth sensor having a sensing range within which a target object lies; acquiring a captured image obtained via an imaging sensor having an angle of view within which the target object lies; performing a first matching process in which first two-dimensional data and third two-dimensional data are referred to, the first two-dimensional data being obtained through a first feature extracting process in which the depth information is referred to, the third two-dimensional data being obtained through a first feature extracting process in which an image resulting from mapping of a three-dimensional model regarding the target object to a two-dimensional space is referred to; performing a second matching process in which second two-dimensional data and fourth two-dimensional data are referred to, the second two-dimensional data being obtained through a second feature extracting process in which the captured image is referred to, the fourth two-dimensional data being obtained through a second feature extracting process in which an image resulting from mapping of the three-dimensional model regarding the target object to the two-dimensional space is referred to; and calculating at least one selected from the group consisting of a position and an attitude of the target object in the three-dimensional space, with reference to a result of the first matching process and a result of the second matching process.

### (Supplementary Note 11)

An information processing system including: a depth information acquiring means for acquiring depth information obtained via a depth sensor having a sensing range within which a target object lies; a captured image acquiring means for acquiring a captured image obtained via an imaging sensor having an angle of view within which the target object lies; a generating means for generating, with reference to first two-dimensional data and third two-dimensional data, one or more candidate solutions regarding at least one selected from the group consisting of a position and an attitude of the target object in a three-dimensional space, the first two-dimensional data being obtained through a first feature extracting process in which the depth information is referred to, the third two-dimensional data being obtained through a first feature extracting process in which an image resulting from mapping of a three-dimensional model regarding the target object to a two-dimensional space is referred to; and a calculating means for calculating, with reference to second two-dimensional data and fourth two-dimensional data and with use of the one or more candidate solutions, at least one selected from the group consisting of the position and the attitude of the target object in the three-dimensional space, the second two-dimensional data being obtained through a second feature extracting process in which the captured image is referred to, the fourth two-dimensional data being obtained through a second feature extracting process in which an image resulting from mapping of the three-dimensional model regarding the target object to the two-dimensional space is referred to.

### (Supplementary Note 12)

An information processing system including: a depth information acquiring means for acquiring depth information obtained via a depth sensor having a sensing range within which a target object lies; a captured image acquiring means for acquiring a captured image obtained via an imaging sensor having an angle of view within which the target object lies; a first matching means for performing a first matching process in which first two-dimensional data and third two-dimensional data are referred to, the first two-dimensional data being obtained through a first feature extracting process in which the depth information is referred to, the third two-dimensional data being obtained through a first feature extracting process in which an image resulting from mapping of a three-dimensional model regarding the target object to a two-dimensional space is referred to; a second matching means for performing a second matching process in which second two-dimensional data and fourth two-dimensional data are referred to, the second two-dimensional data being obtained through a second feature extracting process in which the captured image is referred to, the fourth two-dimensional data being obtained through a second feature extracting process in which an image resulting from mapping of the three-dimensional model regarding the target object to the two-dimensional space is referred to; and a calculating means for calculating at least one selected from the group consisting of a position and an attitude of the target object in the three-dimensional space, with reference to a result of the first matching process and a result of the second matching process.

### (Supplementary Note 13)

A program for causing a computer to operate as the information processing apparatus described in any one of supplementary notes 1 to 8, the program being for causing the computer to function as each of the means.

### (Supplementary Note 14)

An information processing apparatus including: a depth information acquiring means for acquiring depth information obtained via a depth sensor having a sensing range within which a target object lies; a captured image acquiring means for acquiring a captured image obtained via an imaging sensor having an angle of view within which the target object lies; a generating means for generating, with reference to first two-dimensional data and a three-dimensional model regarding the target object, one or more candidate solutions regarding at least one selected from the group consisting of a position and an attitude of the target object in a three-dimensional space, the first two-dimensional data being obtained through a first feature extracting process in which the depth information is referred to; and a calculating means for calculating, with reference to second two-dimensional data and the three-dimensional model and with use of the one or more candidate solutions, at least one selected from the group consisting of the position and the attitude of the target object in the three-dimensional space, the second two-dimensional data being obtained through a second feature extracting process in which the captured image is referred to.

### (Supplementary Note 15)

An information processing apparatus including: a depth information acquiring means for acquiring depth information obtained via a depth sensor having a sensing range within which a target object lies; a captured image acquiring means for acquiring a captured image obtained via an imaging sensor having an angle of view within which the target object lies; a first matching means for performing a first matching process in which first two-dimensional data and a three-dimensional model regarding the target object are referred to, the first two-dimensional data being obtained through a first feature extracting process in which the depth information is referred to; a second matching means for performing a second matching process in which second two-dimensional data and the three-dimensional model are referred to, the second two-dimensional data being obtained through a second feature extracting process in which the captured image is referred to; and a calculating means for calculating at least one selected from the group consisting of a position and an attitude of the target object in the three-dimensional space, with reference to a result of the first matching process and a result of the second matching process.

### (Supplementary Note 16)

An information processing method including: acquiring depth information obtained via a depth sensor having a sensing range within which a target object lies; acquiring a captured image obtained via an imaging sensor having an angle of view within which the target object lies; a generating means for generating, with reference to first two-dimensional data and a three-dimensional model regarding the target object, one or more candidate solutions regarding at least one selected from the group consisting of a position and an attitude of the target object in a three-dimensional space, the first two-dimensional data being obtained through a first feature extracting process in which the depth information is referred to; and calculating, with reference to second two-dimensional data and the three-dimensional model and with use of the one or more candidate solutions, at least one selected from the group consisting of the position and the attitude of the target object in the three-dimensional space, the second two-dimensional data being obtained through a second feature extracting process in which the captured image is referred to.

### (Supplementary Note 17)

An information processing method including: acquiring depth information obtained via a depth sensor having a sensing range within which a target object lies; acquiring a captured image obtained via an imaging sensor having an angle of view within which the target object lies; performing a first matching process in which first two-dimensional data and a three-dimensional model regarding the target object are referred to, the first two-dimensional data being obtained first feature extracting process in which the depth information is referred to; performing a second matching process in which second two-dimensional data and the three-dimensional model are referred to, the second two-dimensional data being obtained through a second feature extracting process in which the captured image is referred to; and calculating at least one selected from the group consisting of a position and an attitude of the target object in the three-dimensional space, with reference to a result of the first matching process and a result of the second matching process.

### (Supplementary Note 18)

An information processing system including: a depth information acquiring means for acquiring depth information obtained via a depth sensor having a sensing range within which a target object lies; a captured image acquiring means for acquiring a captured image obtained via an imaging sensor having an angle of view within which the target object lies; a generating means for generating, with reference to first two-dimensional data and a three-dimensional model regarding the target object, one or more candidate solutions regarding at least one selected from the group consisting of a position and an attitude of the target object in a three-dimensional space, the first two-dimensional data being obtained through a first feature extracting process in which the depth information is referred to; and a calculating means for calculating, with reference to second two-dimensional data and the three-dimensional model and with use of the one or more candidate solutions, at least one selected from the group consisting of the position and the attitude of the target object in the three-dimensional space, the second two-dimensional data being obtained through a second feature extracting process in which the captured image is referred to.

### (Supplementary Note 19)

An information processing system including: a depth information acquiring means for acquiring depth information obtained via a depth sensor having a sensing range within which a target object lies; a captured image acquiring means for acquiring a captured image obtained via an imaging sensor having an angle of view within which the target object lies; a first matching means for performing a first matching process in which first two-dimensional data and a three-dimensional model regarding the target object are referred to, the first two-dimensional data being obtained through a first feature extracting process in which the depth information is referred to; a second matching means for performing a second matching process in which second two-dimensional data and the three-dimensional model are referred to, the second two-dimensional data being obtained through a second feature extracting process in which the captured image is referred to; and a calculating means for calculating at least one selected from the group consisting of a position and an attitude of the target object in the three-dimensional space, with reference to a result of the first matching process and a result of the second matching process.

### (Supplementary Note 20)

A program for causing a computer to operate as the information processing apparatus described in supplementary note 14 or 15, the program being for causing the computer to function as each of the means.

### [Additional Remark 3]

The whole or part of the example embodiments disclosed above can be further described as the following supplementary notes.

An information processing apparatus including at least one processor, the at least one processor performing: a depth information acquiring process of acquiring depth information obtained via a depth sensor having a sensing range within which a target object lies; a captured image acquiring process of acquiring a captured image obtained via an imaging sensor having an angle of view within which the target object lies; a generating process of generating, with reference to first two-dimensional data and third two-dimensional data, one or more candidate solutions regarding at least one selected from the group consisting of a position and an attitude of the target object in a three-dimensional space, the first two-dimensional data being obtained through a first feature extracting process in which the depth information is referred to, the third two-dimensional data being obtained through a first feature extracting process in which an image resulting from mapping of a three-dimensional model regarding the target object to a two-dimensional space is referred to; and a calculating process of calculating, with reference to second two-dimensional data and fourth two-dimensional data and with use of the one or more candidate solutions, at least one selected from the group consisting of and the attitude of the target object in the three-dimensional space, the second two-dimensional data being obtained through a second feature extracting process in which the captured image is referred to, the fourth two-dimensional data being obtained through a second feature extracting process in which an image resulting from mapping of the three-dimensional model regarding the target object to the two-dimensional space is referred to.

It should be noted that this information processing apparatus may further include a memory, and this memory may have stored therein a program for causing the at least one processor to perform the depth information acquiring process, the captured image acquiring process, the generating process, and the calculating process. In addition, this program may be recorded on a computer-readable, non-transitory, and tangible recording medium.

An information processing apparatus including at least one processor, the at least one processor performing: a depth information acquiring process of acquiring depth information obtained via a depth sensor having a sensing range within which a target object lies; a captured image acquiring process of acquiring a captured image obtained via an imaging sensor having an angle of view within which the target object lies; a first matching process of performing a first matching process in which first two-dimensional data and third two-dimensional data are referred to, the first two-dimensional data being obtained through a first feature extracting process in which the depth information is referred to, the third two-dimensional data being obtained through a first feature extracting process in which an image resulting from mapping of a three-dimensional model regarding the target object to a two-dimensional space is referred to; a second matching process of performing a second matching process in which second two-dimensional data and fourth two-dimensional data are referred to, the second two-dimensional data being obtained through a second feature extracting process in which the captured image is referred to, the fourth two-dimensional data being obtained through a second feature extracting process in which an image resulting from mapping of the three-dimensional model regarding the target object to the two-dimensional space is referred to; and a calculating process of calculating at least one selected from the group consisting of a position and an attitude of the target object in the three-dimensional space, with reference to a result of the first matching process and a result of the second matching process.

It should be noted that this information processing apparatus may further include a memory, and this memory may have stored therein a program for causing the at least one processor to perform the depth information acquiring process, the captured image acquiring process, the first matching process, the second matching process, and the calculating process. In addition, this program may be recorded on a computer-readable, non-transitory, and tangible recording medium.

An information processing apparatus including at least one processor, the at least one processor including: a depth information acquiring process of acquiring depth information obtained via a depth sensor having a sensing range within which a target object lies; a captured image acquiring process of acquiring a captured image obtained via an imaging sensor having an angle of view within which the target object lies; a generating process of generating, with reference to first two-dimensional data and a three-dimensional model regarding the target object, one or more candidate solutions regarding at least one selected from the group consisting of a position and an attitude of the target object in a three-dimensional space, the first two-dimensional data being obtained through a first feature extracting process in which the depth information is referred to; and a calculating process of calculating, with reference to second two-dimensional data and the three-dimensional model and with use of the one or more candidate solutions, at least one selected from the group consisting of the position and the attitude of the target object in the three-dimensional space, the second two-dimensional data being obtained through a second feature extracting process in which the captured image is referred to.

It should be noted that this information processing apparatus may further include a memory, and this memory may have stored therein a program for causing the at least one processor to perform the depth information acquiring process, the captured image acquiring process, the generating process, and the calculating process. In addition, this program may be recorded on a computer-readable, non-transitory, and tangible recording medium.

An information processing apparatus including at least one processor, the at least one processor including: a depth information acquiring means for acquiring depth information obtained via a depth sensor having a sensing range within which a target object lies; a captured image acquiring means for acquiring a captured image obtained via an imaging sensor having an angle of view within which the target object lies; a first matching means for performing a first matching process in which first two-dimensional data and a three-dimensional model regarding the target object are referred to, the first two-dimensional data being obtained through a first feature extracting process in which the depth information is referred to; a second matching means for performing a second matching process in which second two-dimensional data and the three-dimensional model are referred to, the second two-dimensional data being obtained through a second feature extracting process in which the captured image is referred to; and a calculating means for calculating at least one selected from the group consisting of a position and an attitude of the target object in the three-dimensional space, with reference to a result of the first matching process and a result of the second matching process.

It should be noted that this information processing apparatus may further include a memory, and this memory may have stored therein a program for causing the at least one processor to perform the depth information acquiring process, the captured image acquiring process, the first matching process, the second matching process, and the calculating process. In addition, this program may be recorded on a computer-readable, non-transitory, and tangible recording medium.

### REFERENCE SIGNS LIST

1, 2, 3, 3A, 3B, 3C: Information processing apparatus
4: Depth sensor
5: RGB camera
6, 6C: Terminal
10, 20, 100, 100A, 100B, 100C: Information processing system
11, 311: Depth information acquiring section
12: Captured image acquiring section
13: Generating section
14, 25: Calculating section
23: First matching section
24: Second matching section
31, 31A, 31B, 31C: Controlling section
32: Outputting section
33: Storing section
312: Depth image feature extracting section
313: Depth image position estimating section
314: RGB image acquiring section
315: RGB image feature extracting section
316: RGB image position estimating section
317: Integrated judgment making section

What is claimed is:

1. An information processing apparatus comprising at least one processor, the at least one processor performing:
a depth information acquiring process of acquiring depth information obtained via a depth sensor having a sensing range within which a target object lies;
a captured image acquiring process of acquiring a captured image obtained via an imaging sensor having an angle of view within which the target object lies;
a generating process of generating, with reference to first two-dimensional data and a three-dimensional model regarding the target object, one or more candidate solutions regarding at least one selected from the group consisting of a position and an attitude of the target object in a three-dimensional space, the first two-dimensional data being obtained through a first feature extracting process in which the depth information is referred to; and
a calculating process of calculating, with reference to second two-dimensional data and the three-dimensional model and with use of the one or more candidate solutions, at least one selected from the group consisting of the position and the attitude of the target object in the three-dimensional space, the second two-dimensional data being obtained through a second feature extracting process in which the captured image is referred to.

2. The information processing apparatus according to claim 1, wherein
the first feature extracting process and the second feature extracting process include an edge extracting process, and
the three-dimensional model contains data on an edge of the target object.

3. The information processing apparatus according to claim 1, wherein
in the depth information acquiring process, the at least one processor acquires depth information in the sensing range even in a case where the target object is not present within the sensing range, and
the first feature extracting process is
a feature extracting process in which subtraction information is referred to, the subtraction information being a difference between the depth information for the target object lying within the sensing range and the depth information for the target object not present within the sensing range.

4. The information processing apparatus according to claim 3, wherein
the first feature extracting process is a feature extracting process in which binarized subtraction information is referred to, the binarized subtraction information being obtained by applying a binarizing process to the subtraction information.

5. The information processing apparatus according to claim 1, wherein
in the calculating process, the at least one processor
applies, to the captured image or the second two-dimensional data, a data deleting process of deleting data which indicates being at a predetermined distance or longer away from positions indicated by the one or more candidate solutions, and
calculates at least one selected from the group consisting of the position and the attitude of the target object in the three-dimensional space, with reference to the captured image or the second two-dimensional data having undergone the data deleting process.

6. The information processing apparatus according to claim 1, wherein
in the generating process, the at least one processor
generates the one or more candidate solutions through a template matching process in which the third two-dimensional data and the first two-dimensional data are referred to.

7. The information processing apparatus according to claim 1, wherein
in the calculating process, the at least one processor
calculates at least one selected from the group consisting of the position and the attitude of the target object in the three-dimensional space through a template matching process in which the fourth two-dimensional data and the second two-dimensional data are referred to.

8. An information processing apparatus comprising at least one processor, the at least one processor performing:
a depth information acquiring process of acquiring depth information obtained via a depth sensor having a sensing range within which a target object lies;
a captured image acquiring process of acquiring a captured image obtained via an imaging sensor having an angle of view within which the target object lies;
a first matching process of performing a first matching process in which first two-dimensional data and a three-dimensional model regarding the target object are referred to, the first two-dimensional data being obtained through a first feature extracting process in which the depth information is referred to;
a second matching process of performing a second matching process in which second two-dimensional data and the three-dimensional model are referred to, the second two-dimensional data being obtained through a second feature extracting process in which the captured image is referred to; and
a calculating process of calculating at least one selected from the group consisting of a position and an attitude of the target object in the three-dimensional space, with reference to a result of the first matching process and a result of the second matching process.

9. An information processing method comprising:
acquiring depth information obtained via a depth sensor having a sensing range within which a target object lies;
acquiring a captured image obtained via an imaging sensor having an angle of view within which the target object lies;
generating, with reference to first two-dimensional data and a three-dimensional model regarding the target object, one or more candidate solutions regarding at least one selected from the group consisting of a position and an attitude of the target object in a three-dimensional space, the first two-dimensional data being obtained through a first feature extracting process in which the depth information is referred to; and
calculating, with reference to second two-dimensional data and the three-dimensional model and with use of the one or more candidate solutions, at least one selected from the group consisting of the position and the attitude of the target object in the three-dimensional space, the second two-dimensional data being obtained through a second feature extracting process in which the captured image is referred to.

10-22. (canceled)
